(19) United States
(12) Patent Application Publication
(10) Pub. No.: US 2018/0039441 A1
(43) Pub. Date: Feb. 8, 2018

(54) STORAGE CONTROL DEVICE, STORAGE SYSTEM, AND METHOD OF CONTROLLING A STORAGE SYSTEM

(71) Applicant: FUJITSU LIMITED, Kawasaki-shi (JP)

(72) Inventors: Koutarou NIMURA, Kawasaki (JP); Hiroyuki Ohshima, Kawasaki (JP); Marie Abe, Kawasaki (JP); Tatsuya Yanagisawa, Kawasaki (JP); Shigeru Akiyama, Kawasaki (JP); Tsukasa Matsuda, Kawasaki (JP)

(73) Assignee: FUJITSU LIMITED, Kawasaki-shi (JP)

(21) Appl. No.: 15/657,364

(22) Filed: Jul. 24, 2017

(30) Foreign Application Priority Data
Aug. 4, 2016 (JP) 2016-154092

(51) Int. Cl. G06F 3/06; G06F 12/02

(52) U.S. Cl. CPC G06F 3/0635; G06F 3/0689; G06F 12/0253; G06F 3/0656; G06F 3/0659

(57) ABSTRACT

A storage control device configured to control a storage apparatus including a plurality of storage devices configured to store data redundantly, the storage control device includes a memory and a processor coupled to the memory and configured to receive a read request that requires to read first data stored in the storage apparatus, determine whether, among the plurality of storage devices of the storage apparatus, a first storage device which stores the first data is under execution of garbage collection, and acquire the first data by accessing a second storage device different from the first storage device, among the plurality of storage devices, when the first storage device is under the execution of the garbage collection.

### CROSS-REFERENCE TO RELATED APPLICATION

This application is based upon and claims the benefit of priority of the prior Japanese Patent Application No. 2016-154092, filed on Aug. 4, 2016, the entire contents of which are incorporated herein by reference.

### FIELD

The embodiments described herein are related to a storage control device, a storage system, and a method of method of controlling a storage system.

### BACKGROUND

In the related art, a storage apparatus with a redundant arrays of inexpensive disks (RAID) configuration that redundantly stores data in a plurality of storage devices, is disclosed. As the storage device, a solid state drive (SSD) may be adopted.

As a technique in the related art, for example, described is a processor that controls an internal process, which is performed during a writing process, to be performed in each of SSDs when any one of the SSDs satisfies a predetermined condition. In addition, for example, described is a technique in which a control unit accesses a first semiconductor storage device or a second semiconductor storage device and, according to the access, dynamically changes a table for management of information identifying the second semiconductor storage device from a plurality of semiconductor storage devices. Further, for example, a technique that efficiently distributes data and that detects and corrects errors among a plurality of solid-state storage devices is described. Examples of related art include Japanese Laid-open Patent Publication No. 2014-59850, International Publication Pamphlet No. WO 2015/008356, and Japanese National Publication of International Patent Application No. 2013-539134.

### SUMMARY

According to an aspect of the invention, a storage control device configured to control a storage apparatus including a plurality of storage devices configured to store data redundantly, the storage control device includes a memory and a processor coupled to the memory and configured to receive a read request that requires to read first data stored in the storage apparatus, determine whether, among the plurality of storage devices of the storage apparatus, a first storage device which stores the first data is under execution of garbage collection, and acquire the first data by accessing a second storage device different from the first storage device, among the plurality of storage devices, when the first storage device is under the execution of the garbage collection.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a storage control method according to an embodiment;

FIG. 2 is an explanatory diagram illustrating a first example of a storage control system 200;

FIG. 3 is an explanatory diagram illustrating a second example of a storage control system 200;

FIG. 4 is an explanatory diagram illustrating a third example of a storage control system 200;

FIG. 5 is a block diagram illustrating an example of a hardware configuration of a storage control device 100;

FIG. 6 is an explanatory diagram illustrating a data structure of a BG control command 600;

FIG. 7 is an explanatory diagram illustrating a data structure of a BG setting command 700;

FIG. 8 is an explanatory diagram illustrating an example of a threshold value to be compared with the capacity of a free space;

FIG. 9 is an explanatory diagram illustrating an example of stored contents of an SSD state table 900;

FIG. 10 is a block diagram illustrating an example of a functional configuration of the storage control device 100;

FIG. 11 is a block diagram illustrating a specific example of a functional configuration of the storage control device 100;

FIG. 12 is an explanatory diagram illustrating an example of updating the SSD state table 900 in the storage control system 200 illustrated in FIG. 3;

FIG. 13 is an explanatory diagram illustrating an example of reading of data in the storage control system 200 illustrated in FIG. 3;

FIG. 14 is an explanatory diagram illustrating an example of writing of data in the storage control system 200 illustrated in FIG. 3;

FIG. 15 is a sequence diagram illustrating an example of a flow of the operation of the storage control device 100 in the storage control system 200 illustrated in FIG. 2;

FIG. 16 is a sequence diagram illustrating an example of a flow of the operation of the storage control device 100 in the storage control system 200 illustrated in FIG. 3;

FIG. 17 is a sequence diagram illustrating another example of a flow of the operation of the storage control device 100 in the storage control system 200 illustrated in FIG. 2;

FIG. 18 is a sequence diagram illustrating another example of a flow of the operation of the storage control device 100 in the storage control system 200 illustrated in FIG. 3;

FIG. 19 is an explanatory diagram illustrating an example of reading of data in the storage control system 200 illustrated in FIG. 4;

FIG. 20 is an explanatory diagram illustrating an example of writing of data in the storage control system 200 illustrated in FIG. 4;

FIG. 21 is a sequence diagram illustrating an example of a flow of the operation of the storage control device 100 in the storage control system 200 illustrated in FIG. 4;

FIG. 22 is a sequence diagram illustrating another example of a flow of the operation of the storage control device 100 in the storage control system 200 illustrated in FIG. 4;

FIG. 23 is a flowchart illustrating an example of GC initialization processing procedure;

FIG. 24 is a flowchart illustrating an example of GC control processing procedure;

FIG. 25 is a flowchart (flowchart 1) illustrating an example of access control processing procedure; and

FIG. 26 is a flowchart (flowchart 2) illustrating an example of access control processing procedure.

### DESCRIPTION OF EMBODIMENTS

In the above-described technique in the related art, response performance of a storage apparatus for an access request may be deteriorated in some cases. For example, while an SSD is in the execution of garbage collection, even in a case where there is a data read request, reading of data is waited until the garbage collection is completed, and this may lead to an increase in response time in some cases.

Hereinafter, a storage control device, a storage control method, and a storage control program according the embodiments will be described in detail with reference to the drawings.

Example of Storage Control Method According to Embodiment

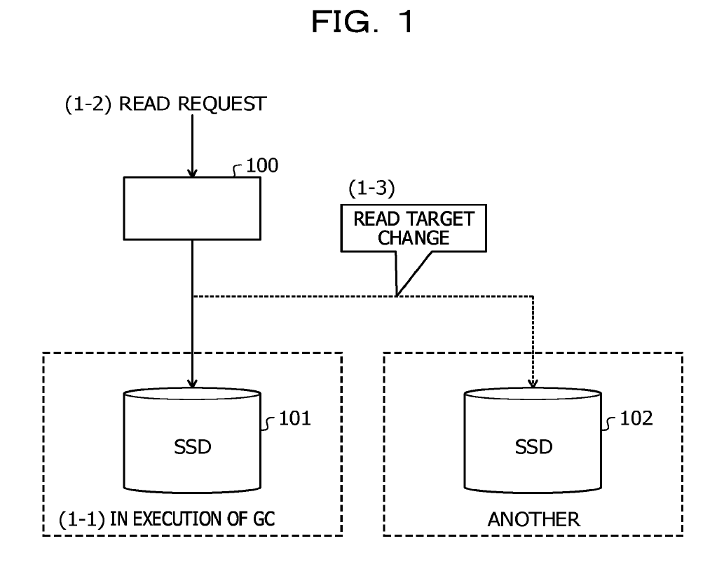

FIG. 1 is an explanatory diagram illustrating an example of a storage control method according to an embodiment. A storage control device 100 is a computer for controlling a storage apparatus that redundantly stores data in a plurality of storage devices. The storage device is, for example, an SSD.

An SSD has a function that automatically executes garbage collection when a capacity of a free space becomes equal to or less than a threshold value after data writing has been performed repeatedly. The free space is an empty area in which data is not written in a storage area of the SSD. The free space does not include an area where garbage data is written, and may be different from a space where a user recognizes as an empty area. In the following description, garbage collection may be referred to as “GC”.

Thus, in a storage apparatus with a RAID configuration that redundantly stores data in a plurality of SSDs, when data is repeatedly written according to write requests from a host apparatus, the SSD automatically executes GC. Thereby, response performance of the storage apparatus for an access request from a host apparatus may be deteriorated in some cases. The access request is a read request or a write request.

For example, while an SSD is in the execution of GC, even when there is a read request from a host apparatus, since it is difficult to read data from the SSD in the execution of GC, reading of data is waited until the SSD completes GC. As a result, there is a case in which response time for a read request is increased, and response performance of the storage apparatus may be deteriorated in some cases. Specifically, there is a possibility that response time may be increased by 1.5 times to 8.0 times compared with response time when the SSD is not in the execution of GC.

In addition, in order to reduce the cost of an SSD, a storage medium with a small maximum capacity may be used for an SSD, and an SSD having a free space with a relatively small maximum capacity may be manufactured in some cases. When the maximum capacity of a free space is relatively small, since the capacity of the free space is likely to be a threshold value or less, the frequency of automatic execution of GC tends to increase. As a result, a probability that there is a read request while the SSD is in the execution of GC also increases, and the number of times that reading of data is waited is likely to be increased. Thus, response performance of the storage apparatus may be deteriorated in some cases.

Therefore, in this embodiment, a storage control method, which may reduce deterioration in response performance for an access request by controlling SSDs such that an SSD in the execution of GC differs from an SSD from which data is read, will be described.

In the example of FIG. 1, a case where an SSD is adopted as a storage device and the storage control device 100 controls the storage apparatus that redundantly stores data in a plurality of SSDs, will be described. The storage apparatus is, for example, an apparatus with a RAID1 configuration. Specifically, the storage apparatus is an apparatus that stores data having the same contents in each SSD by mirroring.

In addition, the storage apparatus may have, for example, a RAID2 configuration, a RAID3 configuration, a RAID4 configuration, a RAID5 configuration, a RAID6 configuration, or the like. Specifically, the storage apparatus may be an apparatus with a RAID5 configuration that distributes data and stores the distributed data in each SSD using an error correction code.

(1-1) The storage control device 100 monitors whether or not each SSD, which is included in the plurality of SSDs that constitute the storage apparatus, is in the execution of GC. According to this configuration, the storage control device 100 may specify, among the plurality of SSDs, an SSD in which GC is not in the execution and thus reading of data is possible, and an SSD in which GC is in the execution and thus reading of data is not possible until GC is completed.

Among the plurality of SSDs, not only one SSD but also several SSDs may be in a state where GC is not in the execution and thus reading of data is possible. Similarly, among the plurality of SSDs, not only one SSD but also several SSDs may be in a state where GC is in the execution and thus reading of data is not possible until GC is completed.

(1-2) In a case where a read request to the storage apparatus is received, the storage control device 100 determines whether or not an SSD as a target of the read request among the plurality of SSDs is in the execution of GC. The storage control device 100 receives a read request from, for example, a host apparatus that is communicably coupled to the storage control device. For example, when the storage apparatus has a RAID1 configuration and a main SSD which is used as a read target is set in advance, the storage control device 100 determines whether or not the main SSD is in the execution of GC.

In addition, for example, when the storage apparatus has a RAID5 configuration, the storage control device 100 may determine whether or not each SSD in which data requested to be read is stored after being distributed is in the execution of GC. According to this configuration, the storage control device 100 may determine whether or not an SSD as a target of a read request is in a state where reading of data is possible.

(1-3) When an SSD as a target of a read request is in the execution of GC, the storage control device 100 acquires data requested to be read, from another SSD 102 different from the SSD 101 which is a target of a read request and is in the execution of GC. Here, for example, it is assumed that, the storage control device 100 determines that the storage apparatus has a RAID1 configuration and that a main SSD is in the execution of GC. At this time, the storage control device 100 acquires data having the same contents as the data requested to be read, from another SSD which stores data having the same contents as the data in the main SSD by mirroring.

On the other hand, for example, when a main SSD is not in the execution of GC, the storage control device 100 may acquire the data requested to be read from the main SSD. Specifically, the storage control device 100 acquires the data requested to be read from the main SSD even when another SSD, which stores data having the same contents as the data in the main SSD by mirroring, is in the execution of GC.

In addition, for example, it is assumed that, the storage control device 100 determines that the storage apparatus has a RAID5 configuration and that an SSD, which stores a portion of the data requested to be read, is in the execution of GC. At this time, the storage control device 100 acquires the remaining portion of the data requested to be read and an error correction code, from another SSDs different from the SSD which stores a portion of the data requested to be read and is in the execution of GC. The storage control device 100 generates data having the same contents as the data requested to be read, based on the remaining portion of the data requested to be read and the error correction code.

On the other hand, for example, when each SSD, which stores each portion of the data requested to be read, is not in the execution of GC, the storage control device 100 acquires each portion of the data. The storage control device 100 may generate data having the same contents as the data requested to be read, based on each portion of the data requested to be read. According to this configuration, the storage control device 100 may acquire data having the same contents as the data requested to be read, without waiting until any one SSD as a target of a read request completes GC.

Therefore, the storage control device 100 may respond to a request source of a read request when acquiring data having the same contents as the data requested to be read, without waiting until an SSD as a target of a read request completes GC. Accordingly, the storage control device 100 may reduce deterioration in response performance for an access request.

Although a case where an SSD automatically executes GC is described, the embodiments described herein are not limited thereto. For example, the storage control device 100 may control the execution of GC in each SSD. According to this configuration, the storage control device 100 may reduce a possibility that the plurality of SSDs simultaneously execute GC and thus there are no SSD in a state where reading of data requested to be read is possible.

Example of Storage Control System 200

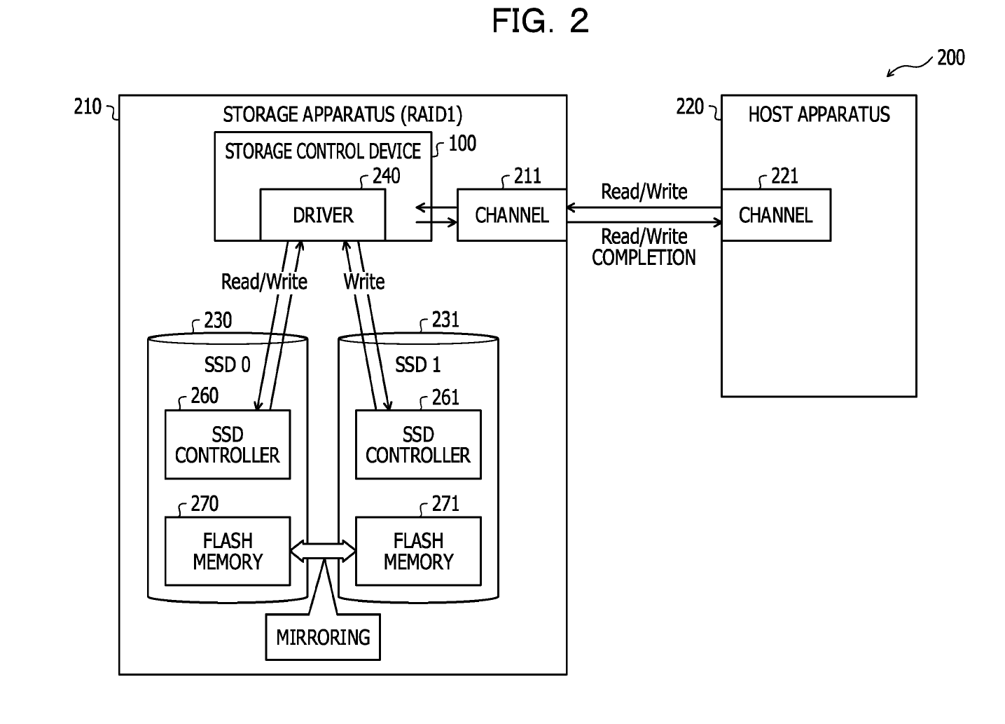

Next, an example of a storage control system 200 to which the storage control device 100 illustrated in FIG. 1 is applied will be described with reference to FIGS. 2 to 4.

FIG. 2 is an explanatory diagram illustrating a first example of a storage control system 200. In FIG. 2, the storage control system 200 includes a storage apparatus 210 and a host apparatus 220. In the storage control system 200, the storage apparatus 210 and the host apparatus 220 are coupled to each other via channels 211 and 221.

In the example of FIG. 2, the storage apparatus 210 has a RAID1 configuration. The storage apparatus 210 includes a storage control device 100, an SSD 230, and an SSD 231. The storage control device 100 is realized by, for example, a RAID controller. The storage control device 100 may communicate with the host apparatus 220 via the channels 211 and 221, and receives an access request from the host apparatus 220.

In a case where a write request is received from the host apparatus 220, the storage control device 100 writes data having the same contents in the SSD 230 and the SSD 231 by mirroring. In a case where a read request is received from the host apparatus 220, the storage control device 100 reads data from the main SSD 230 between the SSD 230 and the SSD 231. The storage control device 100 may transmit a GC execution request to the SSD 230 and the SSD 231. The processing in the storage control device 100 is executed, for example, by a driver 240 included in the storage control device 100.

The SSD 230 includes an SSD controller 260 and a flash memory 270. The SSD controller 260 reads data from the flash memory 270 or writes data in the flash memory 270 under the control of the storage control device 100. The SSD controller 260 executes GC by receiving a GC execution request from the storage control device 100, or automatically.

Similar to the SSD 230, the SSD 231 includes an SSD controller 261 and a flash memory 271. Since the SSD controller 261 is similar to the SSD controller 260, the description thereof will be omitted. Since the flash memory 271 is similar to the flash memory 270, the description thereof will be omitted.

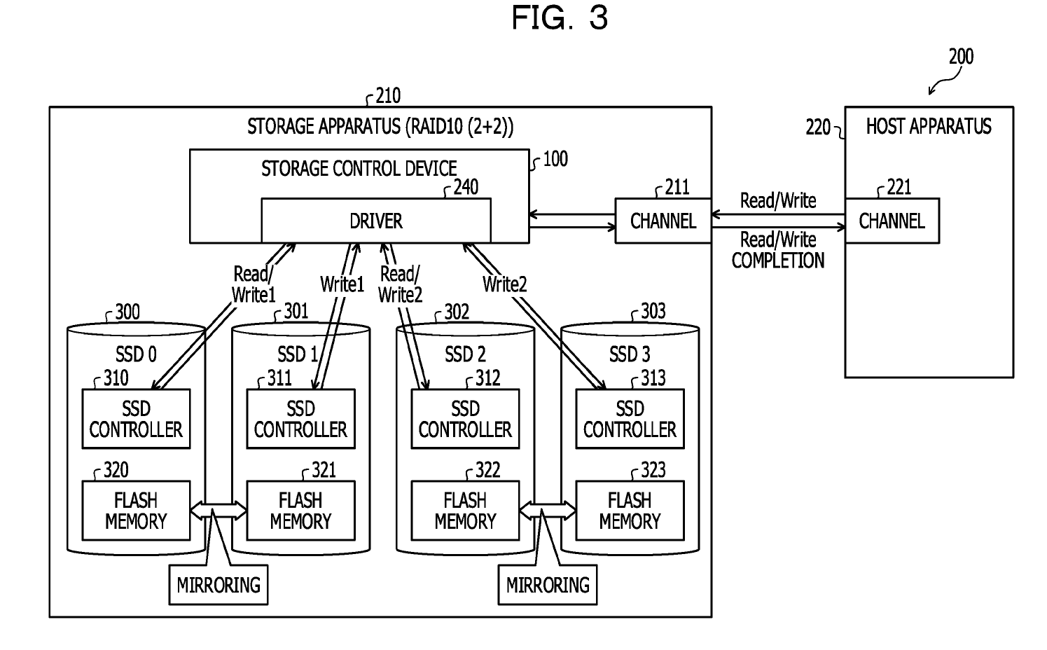

FIG. 3 is an explanatory diagram illustrating a second example of a storage control system 200. In FIG. 3, similar to FIG. 2, the storage control system 200 includes a storage apparatus 210 and a host apparatus 220. In the storage control system 200, the storage apparatus 210 and the host apparatus 220 are coupled to each other via channels 211 and 221.

In the example of FIG. 3, the storage apparatus 210 has a RAID10 configuration. The storage apparatus 210 includes a storage control device 100, an SSD 300, an SSD 301, an SSD 302, and an SSD 303. The storage control device 100 is realized by, for example, a RAID controller. The storage control device 100 may communicate with the host apparatus 220 via the channels 211 and 221, and receives an access request from the host apparatus 220.

In a case where a write request is received from the host apparatus 220, the storage control device 100 distributes data and writes the distributed data in the SSD 300 and the SSD 301, and writes the distributed data having the same contents in the SSD 302 and the SSD 303. In a case where a read request is received from the host apparatus 220, the storage control device 100 reads data from the main SSD 300 and the SSD 302, among the SSD 300, the SSD 301, the SSD 302, and the SSD 303. The storage control device 100 may transmit a GC execution request to the SSD 300, the SSD 301, the SSD 302, and the SSD 303. The processing in the storage control device 100 is executed, for example, by a driver 240 included in the storage control device 100.

The SSDs 300 to 303 include SSD controllers 310 to 313 and flash memories 320 to 323, respectively. Since the SSD controllers 310 to 313 are similar to the SSD controller 260 illustrated in FIG. 2, the description thereof will be omitted. Since the flash memories 320 to 323 are similar to the flash memory 270 illustrated in FIG. 2, the description thereof will be omitted.

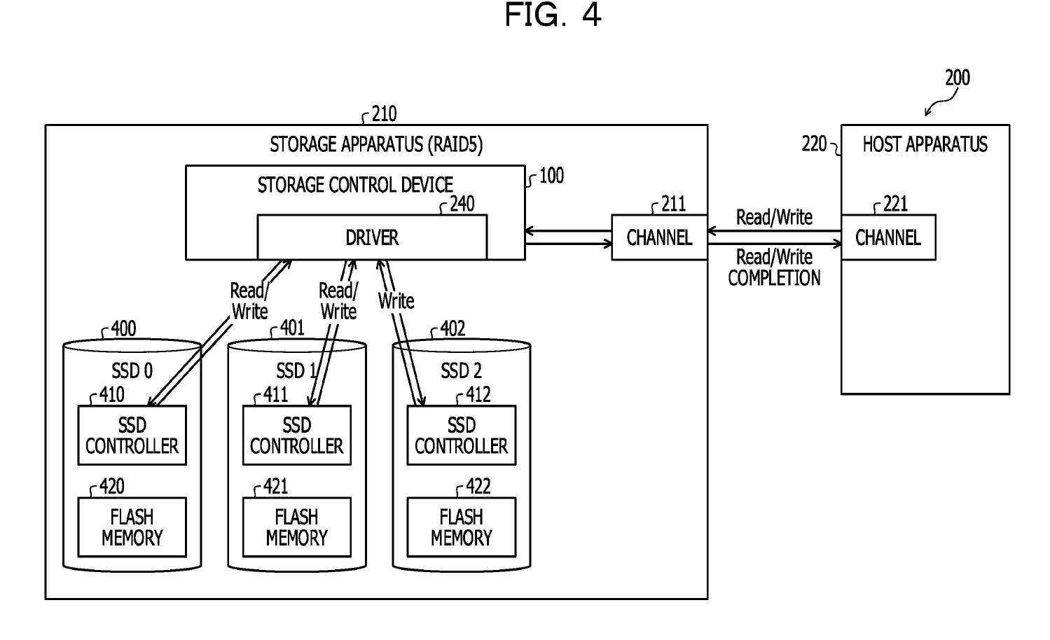

FIG. 4 is an explanatory diagram illustrating a third example of a storage control system 200. In FIG. 4, similar to FIG. 2, the storage control system 200 includes a storage apparatus 210 and a host apparatus 220. In the storage control system 200, the storage apparatus 210 and the host apparatus 220 are coupled to each other via channels 211 and 221.

In the example of FIG. 4, the storage apparatus 210 has a RAID5 configuration. The storage apparatus 210 includes a storage control device 100, an SSD 400, an SSD 401, and an SSD 402. The storage control device 100 is realized by, for example, a RAID controller. The storage control device 100 may communicate with the host apparatus 220 via the channels 211 and 221, and receives an access request from the host apparatus 220.

In a case where a write request is received from the host apparatus 220, the storage control device 100 distributes data and writes the distributed data in the SSD 400 and the SSD 401, and writes an error correction code in the SSD 402. In a case where a read request is received from the host apparatus 220, the storage control device 100 reads data from the SSD 400 and the SSD 401. The storage control device 100 may transmit a GC execution request to the SSD 400, the SSD 401, and the SSD 402. The processing in the storage control device 100 is executed, for example, by a driver 240 included in the storage control device 100.

The SSDs 400 to 402 include SSD controllers 410 to 412 and flash memories 420 to 422, respectively. Since the SSD controllers 410 to 412 are similar to the SSD controller 260 illustrated in FIG. 2, the description thereof will be omitted. Since the flash memories 420 to 422 are similar to the flash memory 270 illustrated in FIG. 2, the description thereof will be omitted.

Example of Hardware Configuration of Storage Control Device 100

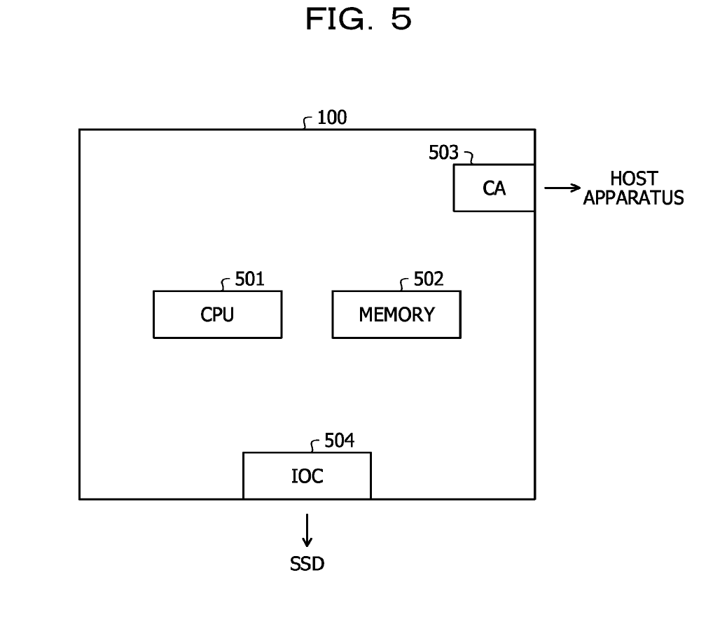

Next, an example of a hardware configuration of the storage control device 100 will be described with reference to FIG. 5.

FIG. 5 is a block diagram illustrating an example of a hardware configuration of the storage control device 100. In FIG. 5, the storage control device 100 includes a central processing unit (CPU) 501, a memory 502, a channel adapter (CA) 503, and a storage I/O controller (IOC) 504. In addition, each component is coupled to each other via a bus.

The CPU 501 controls the whole of the storage control device 100. The memory 502 includes, for example, a read only memory (ROM), a random access memory (RAM), a flash ROM, and the like. Specifically, for example, the flash ROM or the ROM stores various programs, and the RAM is used as a work area of the CPU 501. The various programs may include, for example, a storage control program according to an embodiment. The program stored in the memory 502 is loaded into the CPU 501, thereby causing the CPU 501 to execute the coded processing.

The CA 503 is coupled to another computer via the channels 211 and 221. The CA 503 is coupled, for example, to the host apparatus 220 illustrated in FIG. 2. The CA 503 serves as an interface between the channels 211 and 221 and the inside of the storage control device 100, and controls input and output of data from another computer. The IOC 504 is coupled to the SSDs. The IOC 504 controls input and output of data from the SSDs.

Data Structure of Various Commands

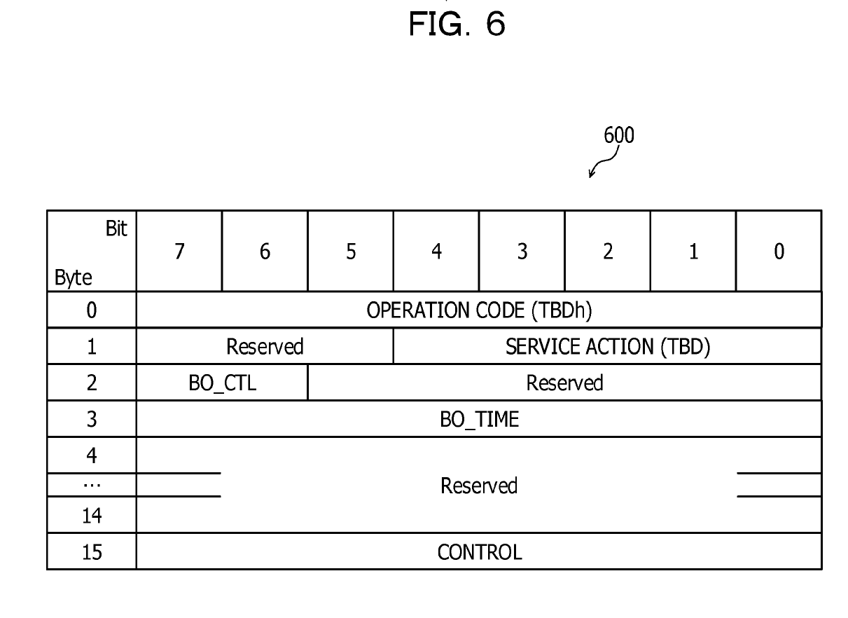

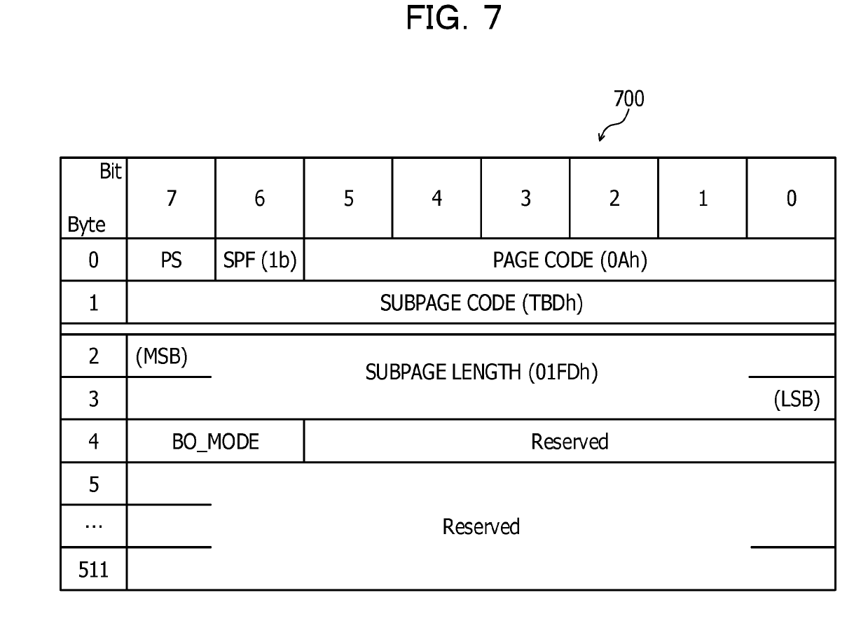

Next, a data structure of various commands, which may be issued by the storage control device 100 and are defined by SCSI block commands-4 (SBC-4), will be described with reference to FIG. 6 and FIG. 7.

FIG. 6 is an explanatory diagram illustrating a data structure of a BG control command 600. The BG control command 600 includes BO_CTL in the sixth and seventh bits of the second byte. BO_CTL is any one of 00b, 01b, 10b, and 11b. 00b indicates that background processing is not changed. The background processing is, for example, GC. 01b indicates that advanced background processing which is set is started. 10b indicates that advanced background processing which is set is stopped. 11b indicates that advanced background processing which is set is reserved. In addition, the BG control command 600 includes BO_TIME in the third byte. BO_TIME indicates a GC execution time by 100 ms as a unit. 100 ms is the minimum time for erase processing in GC.

FIG. 7 is an explanatory diagram illustrating a data structure of a BG setting command 700. The BG setting command 700 includes BO_MODE in the sixth and seventh bits of the fourth byte. BO_MODE is any one of 00b and 01b. 00b indicates that read and write have a higher priority than GC. 01b indicates that GC has a higher priority than read and write.

Example of Threshold Value to be Compared with Capacity of Free Space

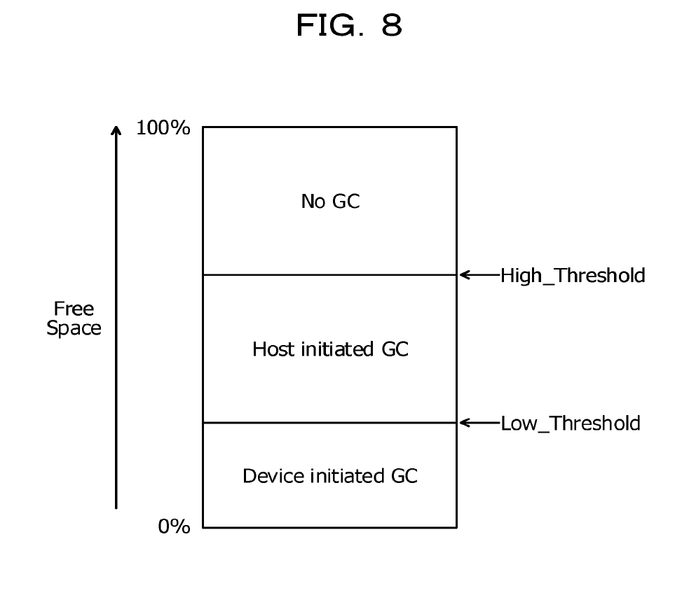

Next, an example of a threshold value, which is set in the storage control device 100 and is to be compared with the capacity of a free space when the storage control device 100 determines whether or not GC is in the execution, will be described with reference to FIG. 8.

FIG. 8 is an explanatory diagram illustrating an example of a threshold value to be compared with the capacity of a free space. As illustrated in FIG. 8, in an SSD, at the time of manufacturing or the like, a low threshold value (Low_Threshold), which is to be compared with the capacity of a free space when determining whether or not the SSD automatically executes GC, is already set. The unit of the low threshold value is, for example, 10%. The low threshold value may be changed according to the use. In this regard, the storage control device 100 sets a high threshold value (High_Threshold) greater than the low threshold value which is set in the SSD, in order to cause the SSD to execute GC before the SSD automatically executes GC. The unit of the high threshold value is, for example, 20%. The high threshold value may be changed according to the use.

A range in which the capacity of a free space is equal to or less than 100% and is greater than the high threshold value, is a range (No GC) in which GC is not executed. A range in which the capacity of a free space is equal to or less than the high threshold value and is greater than the low threshold value, is a range (Host initiated GC) in which the SSD executes GC under the control of the storage control device 100. A range in which the capacity of a free space is equal to or less than the low threshold value and is equal to or greater than 0%, is a range (Device initiated GC) in which the SSD automatically executes GC.

Example of Stored Contents of SSD State Table 900

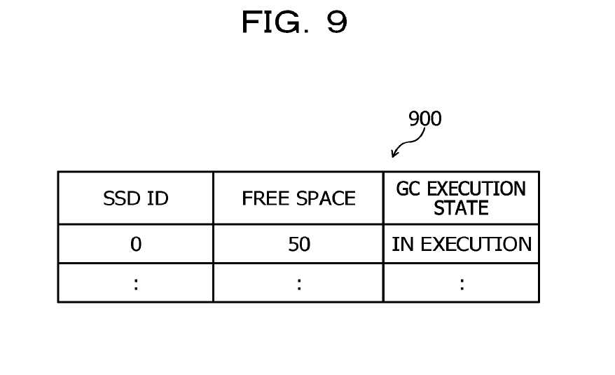

Next, an example of stored contents of an SSD state table 900 which is stored in a storage unit of the storage control device 100 will be described with reference to FIG. 9. The SSD state table 900 is realized by, for example, the memory 502 of the storage control device 100 illustrated in FIG. 3.

FIG. 9 is an explanatory diagram illustrating an example of stored contents of the SSD state table 900. As illustrated in FIG. 9, the SSD state table 900 includes an SSD ID field, a GC execution state field, and a free space field. The SSD state table 900 stores execution status information as a record by setting information in each field for each SSD.

In the SSD ID field, information for identifying an SSD is set. In the GC execution state field, information indicating whether or not an SSD is in the execution of GC is set. In the free space field, the capacity of a free space of an SSD is set.

Example of Functional Configuration of Storage Control Device 100

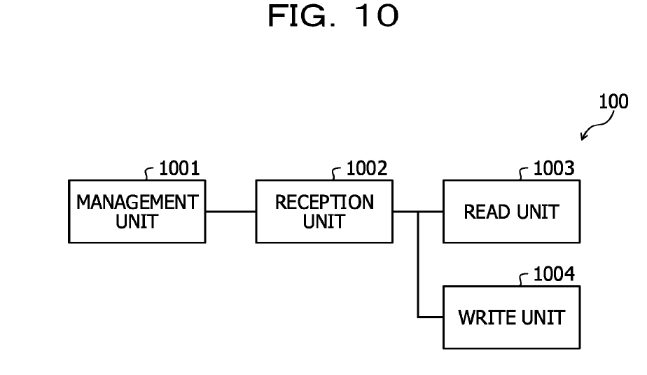

Next, an example of a functional configuration of the storage control device 100 will be described with reference to FIG. 10.

FIG. 10 is a block diagram illustrating an example of a functional configuration of the storage control device 100. The storage control device 100 includes a management unit 1001, a reception unit 1002, a read unit 1003, and a write unit 1004. The management unit 1001 to the write unit 1004 function as a control unit. Specifically, the management unit 1001 to the write unit 1004 cause the CPU 501 to execute a program stored in a storage area such as the memory 502 illustrated in FIG. 5, and thus the functions thereof are realized by the CA 503 or by the IOC 504. The processing result by each functional unit is stored, for example, in a storage area such as the memory 502.

The management unit 1001 measures the capacity of a free space of any one of the plurality of storage devices which constitute the storage apparatus 210. The storage apparatus 210 is an apparatus that redundantly stores data. The storage apparatus 210 is, for example, an apparatus that stores data by mirroring. Specifically, the storage apparatus 210 has a RAID1 configuration. In addition, the storage apparatus 210 may be an apparatus that distributes data and stores the distributed data using an error correction code. Specifically, the storage apparatus 210 may have a RAID5 configuration.

The storage device is a device that includes a storage medium and manages a free space by executing GC. The storage device is, for example, an SSD. The storage medium is, for example, a semiconductor memory. Hereinafter, the storage device will be described as an “SSD”. For example, the management unit 1001 issues a command to each SSD, and measures the capacity of a free space of each SSD. Accordingly, the management unit 1001 may measure the capacity of a free space that is used when determining whether or not the execution of GC by each SSD is preferable.

When the measured capacity of a free space is equal to or less than a threshold value, the management unit 1001 causes any one SSD to execute GC. The GC execution time is set to, for example, one second. At this time, when the storage apparatus 210 has a RAID1 configuration, until the any one SSD completes GC, the management unit 1001 cause the SSD, which stores data having the same contents as the data of the any one SSD by mirroring, not to execute GC. When the any one SSD completes GC, the management unit 1001 causes the SSD, which stores data having the same contents as the any one SSD by mirroring, to execute GC. When an SSD is caused to execute GC, and when an SSD completes GC, the management unit 1001 manages whether or not an SSD is in the execution of GC by updating the SSD state table 900. Accordingly, the management unit 1001 may cause the plurality of SSDs, which store data having the same contents by mirroring, not to simultaneously execute GC.

When the measured capacity of a free space is equal to or less than a threshold value, the management unit 1001 causes any one SSD to execute GC. At this time, when the storage apparatus 210 has a RAID5 configuration, until the any one SSD completes GC, the management unit 1001 cause the SSD, which is different from the any one SSD, not to execute GC. When an SSD is caused to execute GC, and when an SSD completes GC, the management unit 1001 manages whether or not an SSD is in the execution of GC by updating the SSD state table 900. Accordingly, the management unit 1001 may cause the plurality of SSDs not to simultaneously execute GC.

The management unit 1001 may adopt a value, which is greater than the capacity of a free space when it is determined that any one SSD automatically executes GC, as a threshold value to be compared with the capacity of a free space. The capacity of the free space when it is determined that an SSD automatically executes GC is, for example, the above-described low threshold value. For example, the management unit 1001 adopts the above-described high threshold value, as a threshold value to be compared with the capacity of a free space. Accordingly, the management unit 1001 may cause an SSD not to automatically execute GC, and thus it is easier to manage whether or not an SSD is in the execution of GC.

The management unit 1001 monitors whether or not each SSD of the plurality of SSDs is in the execution of GC. The management unit 1001 determines whether or not each SSD is in the execution of GC by, for example, referring to the SSD state table 900. For example, even in a case where the SSD state table 900 is not present, among the plurality of SSDs, when there is an SSD with a free space of which the measured capacity is equal to or less than a low threshold value, the management unit 1001 may determine that the SSD is in the execution of GC.

When an SSD responds to a command for inquiring whether or not GC is in the execution, the management unit 1001 may monitor whether or not each SSD is in the execution of GC by inquiring of each SSD whether or not GC is in the execution. Accordingly, the management unit 1001 may determine whether or not each SSD is in a state where reading and writing of data is possible.

The reception unit 1002 receives an access request to the storage apparatus 210. The access request is, for example, a read request or a write request. For example, the reception unit 1002 receives a read request to the storage apparatus 210, from the host apparatus 220. In addition, the reception unit 1002 receives a write request to the storage apparatus 210, from the host apparatus 220.

In a case where a read request to the storage apparatus 210 is received, the read unit 1003 determines whether or not an SSD as a target of the read request among the plurality of SSDs is in the execution of GC. When GC is in the execution, the read unit 1003 acquires data requested to be read, from another SSD different from the SSD which is a target of the read request among the plurality of SSDs.

For example, when the storage apparatus 210 has a RAID1 configuration, the read unit 1003 determines whether or not the main SSD, which is a target of the read request, is in the execution of GC. In a case where the main SSD is in the execution of GC, the read unit 1003 acquires data having the same contents as the data requested to be read that is stored in another SSD by mirroring. On the other hand, when the main SSD is not in the execution of GC, the read unit 1003 acquires the data requested to be read from the main SSD. Accordingly, the read unit 1003 may respond to a request source of the read request even before an SSD as a target of the read request completes GC.

For example, when the storage apparatus 210 has a RAID5 configuration, the read unit 1003 determines whether or not an SSD, which stores a portion of data requested to be read, is in the execution of GC. In addition, the read unit 1003 determines whether or not an SSD as a target of the read request, which stores an error correction code corresponding to the data requested to be read, is in the execution of GC.

When an SSD, which stores a portion of the data, is in the execution of GC, the read unit 1003 acquires, from another SSD, the remaining portion of the data requested to be read and an error correction code corresponding to the data requested to be read, and generates the data requested to be read. On the other hand, when an SSD, which stores an error correction code, is in the execution of GC, the read unit 1003 acquires each portion of the data requested to be read from other SSDs, and generates the data requested to be read. Accordingly, the read unit 1003 may respond to a request source of the read request even before an SSD as a target of the read request completes GC.

The read unit 1003 responds to a request source of the read request when the data requested to be read is acquired. In addition, the read unit 1003 may respond to a request source of the read request when data having the same contents as the data requested to be read is acquired. Therefore, the read unit 1003 may respond to a request source of a read request when acquiring data having the same contents as the data requested to be read, without waiting until an SSD as a target of a read request completes GC. Accordingly, the read unit 1003 may reduce deterioration in response performance for an access request.

The write unit 1004 writes data in an SSD, for example, in a write-back format. Thus, when a write request to the storage apparatus 210 is received, the write unit 1004 responds to a request source of the write request. Accordingly, the write unit 1004 may reduce deterioration in response performance for an access request.

In a case where a write request to the storage apparatus 210 is received, the write unit 1004 determines whether or not an SSD as a target of the write request among the plurality of SSDs is in the execution of GC. When any one SSD as a target of the write request is in the execution of GC, the write unit 1004 stores the data requested to be written in a temporary storage area. The temporary storage area is, for example, a queue. The queue is generated, for example, for each SSD. In the queue, the data requested to be written is stored, in correlation with an SSD as a target of the write request, an LBA, an SCSI command, and the like.

For example, when the storage apparatus 210 has a RAID1 configuration, the write unit 1004 determines whether or not the main SSD and another SSD which stores data having the same contents as the data of the main SSD by mirroring, are in the execution of GC. When the main SSD is in the execution of GC, the write unit 1004 stores, in a queue, data to be written in the main SSD, in correlation with the main SSD. On the other hand, when the another SSD is in the execution of GC, the write unit 1004 stores, in a queue, data to be written in the another SSD, in correlation with the another SSD.

For example, in a case where the storage apparatus 210 has a RAID5 configuration, the write unit 1004 determines whether or not an SSD which writes a portion of the data requested to be written and an SSD which writes an error correction code corresponding to the data requested to be written, are in the execution of GC. When an SSD which writes a portion of the data requested to be written is in the execution of GC, the write unit 1004 stores, in a queue, a portion of the data requested to be written, in correlation with an SSD which writes a portion of the data requested to be written. On the other hand, when an SSD which writes an error correction code corresponding to the data requested to be written is in the execution of GC, the write unit 1004 stores, in a queue, the error correction code, in correlation with an SSD which writes the error correction code.

When an SSD as a target of the write request completes GC, the write unit 1004 collectively writes the data stored in the temporary storage area, in the SSD as a target of the write request. The write unit 1004 collects, among the data stored in the queue, data to be written in the same unit storage area of the SSD, and writes the collected data in the SSD at a time. The write unit 1004 may collect, among the data stored in the queue, data to be written in successive storage areas of the SSD, and successively write the collected data in the SSD. Accordingly, the write unit 1004 may reduce the number of times of writing, and improve writing performance.

Before an SSD as a target of the write request completes GC, and further, in a case where an access request to a storage area as a write target of the data requested to be written is received, the write unit 1004 causes the SSD as a target of the write request to stop GC. Then, the write unit 1004 writes the data requested to be written in the SSD as a target of the write request. Accordingly, even in a case where it is not preferable to read data from an SSD unless the data is written in the SSD, the write unit 1004 may respond to a request source of the read request.

In addition, in this way, in a case where it is not preferable to write data currently requested to be written in an SSD unless data previously requested to be written is written in the SSD, the write unit 1004 may write the data currently requested to be written in the SSD. Accordingly, the write unit 1004 may respond to a request source of the current write request, and may reduce deterioration in response performance for an access request.

Specific Example of Functional Configuration of Storage Control Device 100

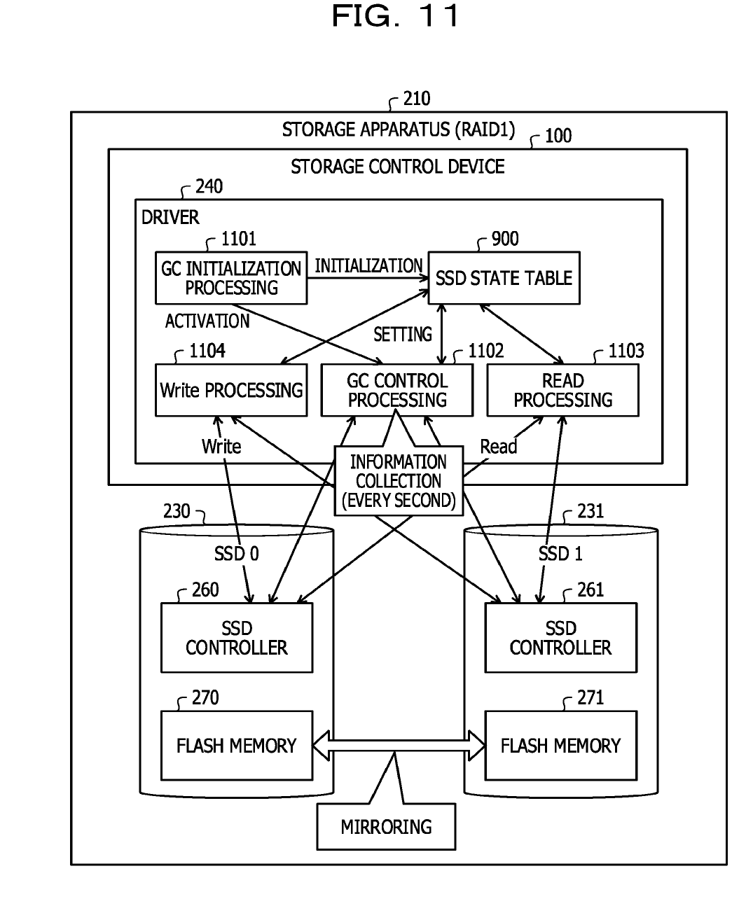

Next, a specific example of a functional configuration of the storage control device 100 will be described with reference to FIG. 11. In the example of FIG. 11, a specific example of a functional configuration of the storage control device 100 will be described by using the storage control device 100 in the storage control system 200 illustrated in FIG. 2 as an example.

FIG. 11 is a block diagram illustrating a specific example of a functional configuration of the storage control device 100. A driver 240 of the storage control device 100 includes, for example, an SSD state table 900, and may execute GC initialization processing 1101, GC control processing 1102, read processing 1103, and write processing 1104.

In the GC initialization processing 1101, preparation for other processing is performed by initializing the SSD state table 900. In the GC control processing 1102, the capacities of free spaces of, for example, the SSDs 230 and 231 are acquired, and a GC execution control is performed when the capacities of free spaces of the SSDs 230 and 231 are equal to or less than a high threshold value. By using the GC control processing 1102, for example, the above-described management unit 1001 may be realized.

In the read processing 1103, a control for reading of data from the SSDs 230 and 231 is performed by, for example, transmitting a read command to the SSDs 230 and 231. In the read processing 1103, transmission of the read command to any one of the SSDs 230 and 231 is controlled by referring to the SSD state table 900. By using the read processing 1103, for example, the above-described read unit 1003 may be realized.

In the write processing 1104, a control for writing of data in the SSDs 230 and 231 is performed by, for example, transmitting a write command to the SSDs 230 and 231. In the write processing 1104, when the write command is transmitted to the SSDs 230 and 231 is controlled by referring to the SSD state table 900. By using the write processing 1104, for example, the above-described write unit 1004 may be realized.

In the following description, the operation of the storage control device 100 in the storage control system 200 illustrated in FIGS. 2 to 4 will be described.

Example of Operation of Storage Control Device 100 in Storage Control System 200 Illustrated in FIG. 3

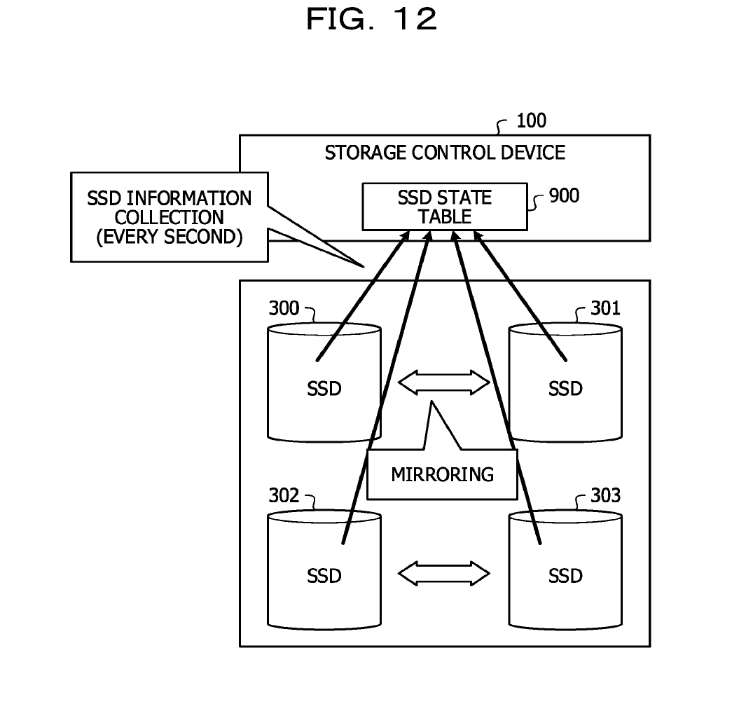

First, an example of the operation of the storage control device 100 in the storage control system 200 illustrated in FIG. 3 will be described with reference to FIGS. 12 to 14. Here, an example of the operation of the storage control device 100 in the storage control system 200 illustrated in FIG. 2 is the same as an example of the operation of the storage control device 100 in the storage control system 200 illustrated in FIG. 3, and thus the description thereof will be omitted.

FIG. 12 is an explanatory diagram illustrating an example of updating the SSD state table 900 in the storage control system 200 illustrated in FIG. 3. In FIG. 12, the storage control device 100 acquires, from each of the SSDs 300 to 303, the capacity of a free space of each of the SSDs 300 to 303 at a predetermined time interval. The storage control device 100 updates the SSD state table 900 based on the acquired capacity of a free space.

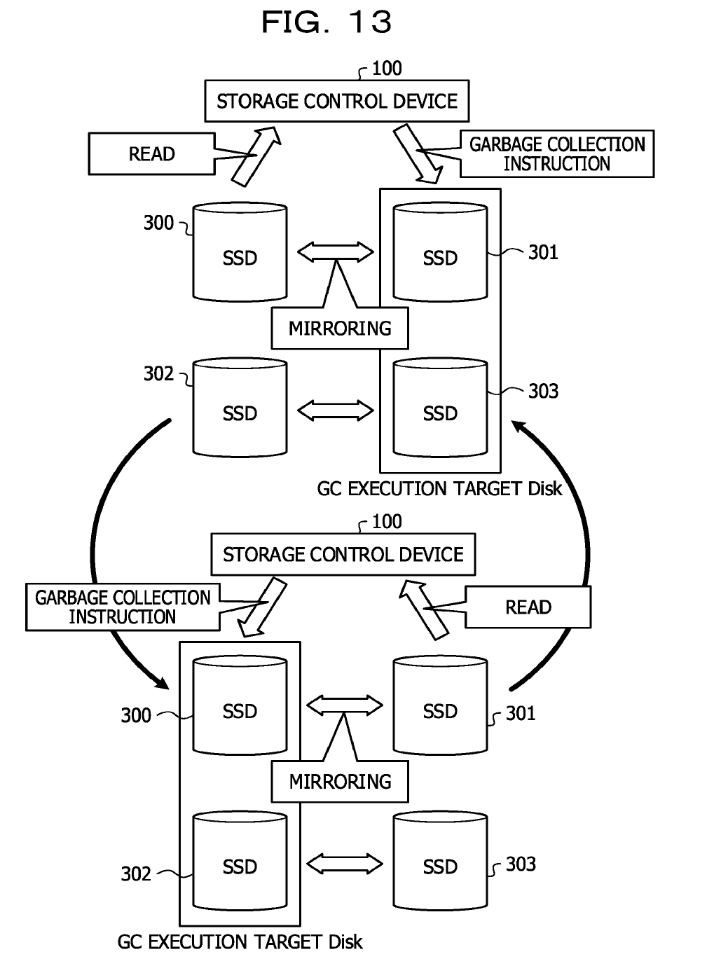

Accordingly, the storage control device 100 may acquire the capacity of a free space that is used when determining whether or not the execution of GC by each SSD is preferable. Before an SSD automatically executes GC, the storage control device 100 causes the SSD to execute GC, and thus it easier to manage the GC execution state of the SSD. The description proceeds to the explanation of FIG. 13.

FIG. 13 is an explanatory diagram illustrating an example of reading of data in the storage control system 200 illustrated in FIG. 3. In FIG. 13, the storage control device 100 determines whether or not the capacity of a free space of each of the SSDs 300 to 303 is equal to or less than a high threshold value. For example, in a case where the capacity of a free space of the SSD 301 is equal to or less than the high threshold value, the storage control device 100 issues a command for causing the SSD 301 to execute GC. In addition, the storage control device 100 also issues a command for causing the SSD 303, which stores data being distributed together with the SSD 301, to execute GC. The storage control device 100 manages the GC execution states of the SSDs 301 and 303 using the SSD state table 900.

Here, until the SSD 301 and the SSD 303 complete GC, the storage control device 100 cause the SSD 300 and the SSD 302, which store data having the same contents as the data of the SSD 301 and the SSD 303 by mirroring, not to execute GC. Until the SSD 301 and the SSD 303 complete GC, the storage control device 100 reads data from the SSD 300 and the SSD 302, which store data having the same contents as the data of the SSD 301 and the SSD 303 by mirroring.

Thereafter, when the SSD 301 and the SSD 303 complete GC, the storage control device 100 issues a command for causing the SSD 300 and the SSD 302, which store data having the same contents as the data of the SSD 301 and the SSD 303 by mirroring, to execute GC. The storage control device 100 manages the GC execution states of the SSDs 301 to 303 using the SSD state table 900.

Here, until the SSD 300 and the SSD 302 complete GC, the storage control device 100 cause the SSD 301 and the SSD 303 not to execute GC. In addition, until the SSD 300 and the SSD 302 complete GC, the storage control device 100 reads data from the SSD 301 and the SSD 303. When the SSD 300 and the SSD 302 complete GC, the storage control device 100 manages the GC execution states of the SSDs 300 and 302 using the SSD state table 900.

Accordingly, the storage control device 100 may cause a pair of SSDs, which store data having the same contents by mirroring, not to simultaneously execute GC, and cause at least one SSD of a pair of SSDs to be in a state where reading of data is possible. As a result, even when an SSD as a target of the read request is in the execution of GC, the storage control device 100 may acquire data having the same contents as the data requested to be read, and respond to a request source of the read request.

Although a case where the storage control device 100 reads data from an SSD in which GC is not in the execution while managing the GC execution states of SSDs by causing the SSDs to execute GC, is described, the embodiments described herein are not limited thereto. For example, the storage control device 100 may determine whether or not each SSD is in the execution of GC based on the capacity of a free space of each SSD, and determine an SSD for reading of data.

Specifically, for example, there is a case where the capacities of free spaces of the SSD 300 and the SSD 302 are equal to or less than a low threshold value, and where the capacities of free spaces of the SSD 301 and the SSD 303 are greater than a low threshold value. In this case, the storage control device 100 determines that the SSD 300 and the SSD 302 are in the execution of GC and that the SSD 301 and the SSD 303 are not in the execution of GC, and reads data from the SSD 301 and the SSD 303.

On the other hand, specifically, there is a case where the capacities of free spaces of the SSD 300 and the SSD 302 are greater than a low threshold value, and where the capacities of free spaces of the SSD 301 and the SSD 303 are equal to or less than a low threshold value. In this case, the storage control device 100 determines that the SSD 300 and the SSD 302 are not in the execution of GC and that the SSD 301 and the SSD 303 are in the execution of GC, and reads data from the SSD 300 and the SSD 302. Accordingly, even when an SSD as a target of the read request is in the execution of GC, the storage control device 100 may acquire data having the same contents as the data requested to be read, and respond to a request source of the read request.

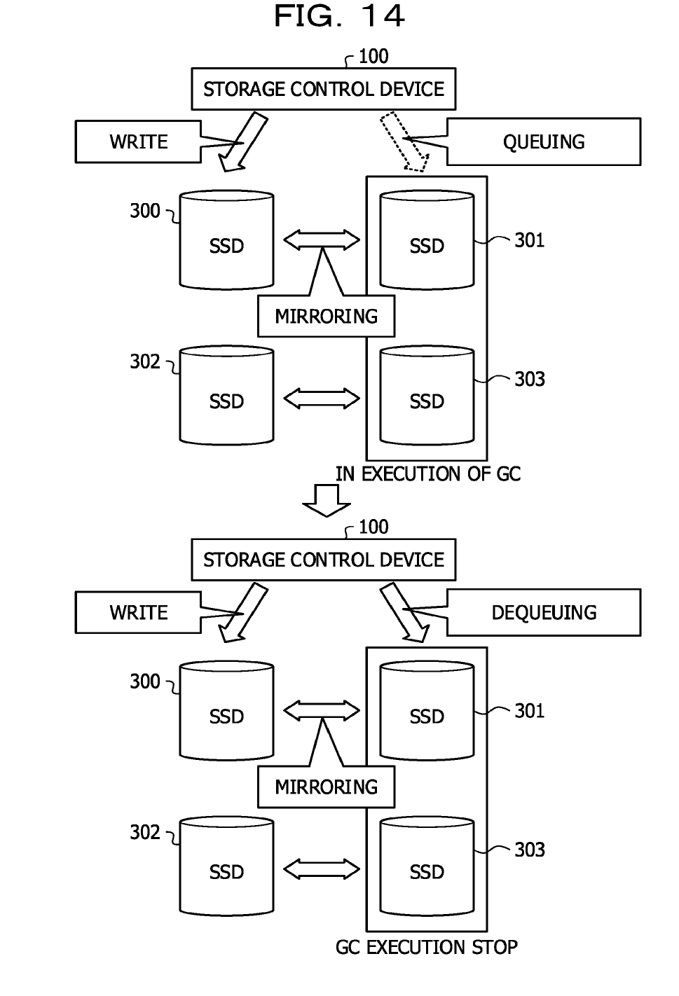

In addition, the storage control device 100 may determine an SSD for reading of data by, for example, inquiring of each SSD whether or not GC is in the execution. Accordingly, even when an SSD as a target of the read request is in the execution of GC, the storage control device 100 may acquire data having the same contents as the data requested to be read, and respond to a request source of the read request. The description proceeds to the explanation of FIG. 14.

FIG. 14 is an explanatory diagram illustrating an example of writing of data in the storage control system 200 illustrated in FIG. 3. In FIG. 14, it is assumed that the storage control device 100 receives a write request for writing write data 1 in the SSD 300 while the SSD 301 and the SSD 303 are in the execution of GC.

The storage control device 100 writes the write data 1 in the SSD 300 and the SSD 301 by mirroring, according to the write request. The storage control device 100 responds to a request source of the write request when receiving the write request, even before the write data 1 is written in the SSD 300 and the SSD 301 in a write-back format.

At this time, since the SSD 301 is in the execution of GC, the storage control device 100 stores the write data 1 in a queue in correlation with the SSD 301, and waits for the write data 1 to be written in the SSD 301. On the other hand, the storage control device 100 writes the write data 1 in the SSD 300.

Thereafter, when the SSD 301 completes GC, the storage control device 100 writes, in the SSD 301, the write data 1 stored in the queue. When there are a plurality of pieces of data stored in the queue, the storage control device 100 collectively writes, in the SSD, the plurality of pieces of data, and thus the number of times of writing may be reduced.

In addition, it is assumed that, before the SSD 301 completes GC, the storage control device 100 receives a write request for overwriting the write data 1 with write data 2 in the SSD 300. Here, the storage control device 100 overwrites the write data 1 with the write data 2 in the SSD 300 and the SSD 301 by mirroring. Actually, in the SSD, the write data 1 is overwritten in the form of the write data 2, the write data 1 is not deleted but set as unnecessary data, and the write data 2 is newly written.

At this time, according to the write-back format, even before the write data 2 is written in the SSD 300 and the SSD 301, the storage control device 100 responds to a request source of the write request when receiving the write request. However, in some cases, it may not be preferable to respond to a request source of the current write request according to the write-back format unless the write data 1 previously requested to be written is written in the SSD.

Therefore, the storage control device 100 causes the SSD 301 to stop GC, extracts the write data 1 from the queue, and writes the write data 1 in the SSD 301. In the following description, in some cases, the operation of stopping GC and writing data extracted from the queue in the SSD is referred to as “rearrangement writing”. When the write data 1 is written in the SSD 301, the storage control device 100 responds to a request source of the write request of the write data 2. The storage control device 100 stores the write data 2 in a queue in correlation with the SSD 301, causes the SSD 301 to restart GC, and waits for the write data 2 to be written in the SSD 301.

The storage control device 100 may further write the write data 2 in the SSD 301, and then causes the SSD 301 to restart GC. On the other hand, the storage control device 100 writes the write data 2 in the SSD 300. Accordingly, even in a case where it is not preferable to respond to a request source of the current write request unless the data previously requested to be written is written in the SSD, the storage control device 100 may reduce deterioration in response performance for an access request.

Although a case where it is not preferable to respond to a request source of the current write request unless the write data previously requested to be written is written in the SSD, is described, the embodiments described herein are not limited thereto. For example, in some cases, even when the write data previously requested to be written is not written in an SSD, it may be preferable to respond to a request source of the current write request. In this case, the storage control device 100 may merge the write data previously requested to be written and the write data currently requested to be written, and store the new write data in a queue. Accordingly, the storage control device 100 may reduce deterioration in write performance.

Although a case where it is not preferable to respond to a request source of the current write request unless the write data previously requested to be written is written in the SSD, is described, the embodiments described herein are not limited thereto. For example, in some cases, it may not be preferable to respond to a request source of the read request for reading the write data previously requested to be written unless the write data previously requested to be written is written in the SSD. In this case, the storage control device 100 causes the SSD to stop GC, writes the write data previously requested to be written in the SSD, and then responds to a request source of the read request. Accordingly, the storage control device 100 may reduce deterioration in response performance for an access request.

In addition, for example, in some cases, even when the write data previously requested to be written is not written in an SSD, it may be preferable to respond to a request source of the read request for reading the write data previously requested to be written. In this case, the storage control device 100 reads, from an SSD in which GC is not in the execution, data having the same contents as the data requested to be read, and responds to a request source of the read request. Accordingly, the storage control device 100 may reduce deterioration in response performance for an access request.

Example of Flow of Operation of Storage Control Device 100

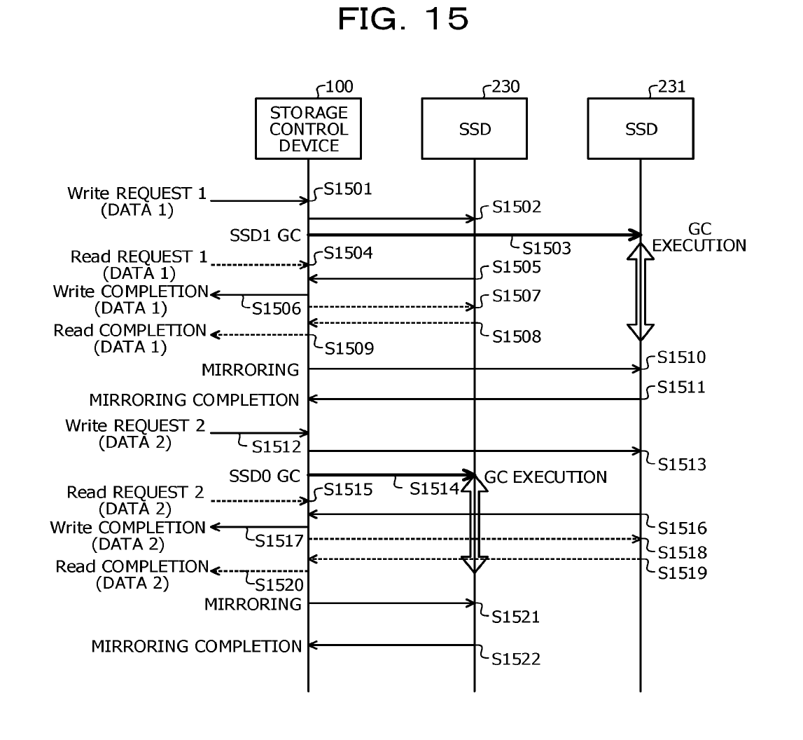

Next, an example of a flow of the operation of the storage control device 100 in the storage control system 200 illustrated in FIG. 2 will be described with reference to FIG. 15.

FIG. 15 is a sequence diagram illustrating an example of a flow of the operation of the storage control device 100 in the storage control system 200 illustrated in FIG. 2. In FIG. 15, the storage control device 100 receives a write request 1 of data 1 (step S1501). The storage control device 100 transmits a write command of the data 1 to the SSD 230, according to the write request 1 (step S1502). At this time, since the capacity of the free space of the SSD 231 is equal to or less than a threshold value, the storage control device 100 transmits a command for GC execution to the SSD 231, before transmitting the write command of the data 1 according to the write request 1, to the SSD 231 (step S1503).

The storage control device 100 receives a read request 1 of the data 1, but waits until there is a response to the write command of the data 1, before transmitting a read command of the data 1 to the SSD 230 according to the read request 1 of the data 1 (step S1504). The storage control device 100 receives a response to the write command of the data 1, from the SSD 230 (step S1505). The storage control device 100 outputs the write completion of the data 1 (step S1506).

When there is a response to the write command of the data 1, the storage control device 100 transmits the read command of the data 1 according to the read request 1 of the data 1, to the SSD 230 (step S1507). The storage control device 100 receives the data 1 according to the read request 1, from the SSD 230 (step S1508). The storage control device 100 outputs the read completion of the data 1 (step S1509).

When the SSD 231 completes GC, the storage control device 100 transmits the write command of the data 1 according to the write request 1, to the SSD 231 (step S1510). The storage control device 100 receives a response to the write command of the data 1, from the SSD 231 (step S1511).

The storage control device 100 receives a write request 2 of data 2 (step S1512). The storage control device 100 transmits a write command of the data 2 to the SSD 231, according to the received write request 2 (step S1513). At this time, since the capacity of the free space of the SSD 230 is equal to or less than a threshold value, the storage control device 100 transmits a command for GC execution to the SSD 230, before transmitting the write command of the data 2 according to the write request 2, to the SSD 230 (step S1514).

The storage control device 100 receives a read request 2 of the data 2, but waits until there is a response to the write command of the data 2, before transmitting a read command of the data 2 to the SSD 231 according to the read request 2 of the data 2 (step S1515). The storage control device 100 receives a response to the write command of the data 2, from the SSD 231 (step S1516). The storage control device 100 outputs the write completion of the data 2 (step S1517).

Even though there is a response to the write command of the data 2, since the SSD 230 as a target of the read request 2 of the data 2 is in the execution of GC, the storage control device 100 transmits the read command of the data 2 to the SSD 231 instead of the SSD 230 (step S1518). The storage control device 100 receives the data 2 according to the read request 2, from the SSD 231 (step S1519). The storage control device 100 outputs the read completion of the data 2 (step S1520).

When the SSD 230 completes GC, the storage control device 100 transmits the write command of the data 2 according to the write request 2, to the SSD 230 (step S1521). The storage control device 100 receives a response to the write command of the data 2, from the SSD 230 (step S1522).

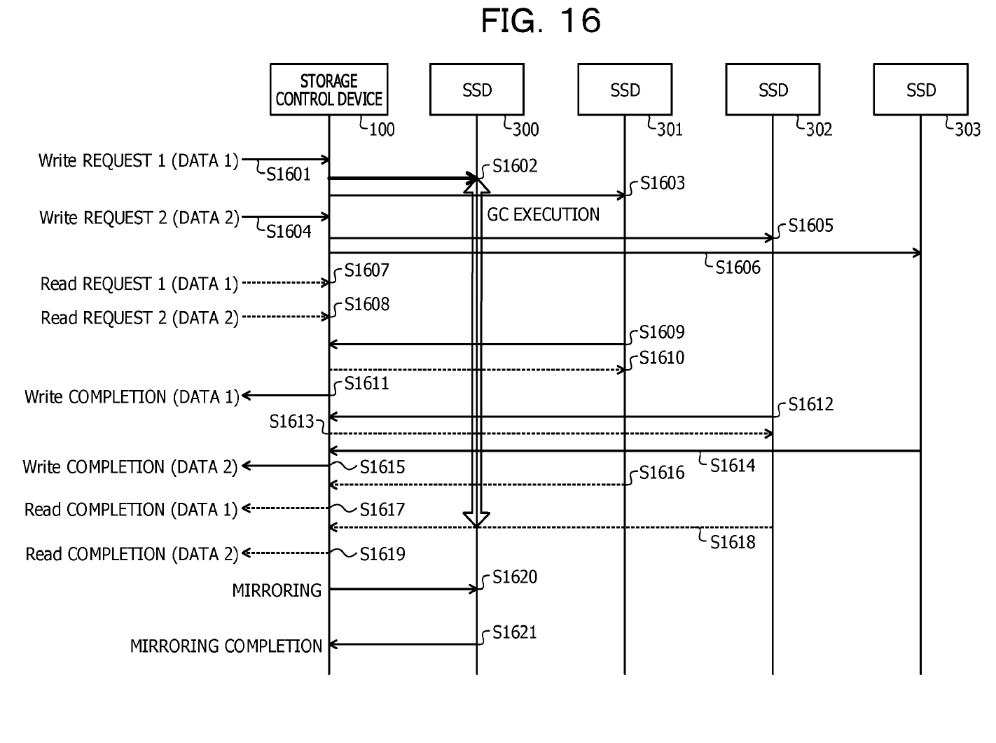

Next, an example of a flow of the operation of the storage control device 100 in the storage control system 200 illustrated in FIG. 3 will be described with reference to FIG. 16.

FIG. 16 is a sequence diagram illustrating an example of a flow of the operation of the storage control device 100 in the storage control system 200 illustrated in FIG. 3. In FIG. 16, the storage control device 100 receives a write request 1 of data 1 (step S1601). At this time, since the capacity of the free space of the SSD 300 is equal to or less than a threshold value, the storage control device 100 transmits a command for GC execution to the SSD 300, before transmitting the write command of the data 1 according to the write request 1, to the SSD 300 (step S1602). In addition, the storage control device 100 transmits a write command of the data 1 to the SSD 301, according to the write request 1 (step S1603).

The storage control device 100 receives a write request 2 of data 2 (step S1604). The storage control device 100 transmits a write command of the data 2 to the SSD 302, according to the write request 2 (step S1605). In addition, the storage control device 100 transmits a write command of the data 2 to the SSD 303, according to the write request 2 (step S1606).

The storage control device 100 receives a read request 1 of the data 1, but waits until there is a response to the write command of the data 1, before transmitting a read command of the data 1 to the SSD 300 according to the read request 1 of the data 1 (step S1607). In addition, the storage control device 100 receives a read request 2 of the data 2, but waits until there is a response to the write command of the data 2, before transmitting a read command of the data 2 to the SSD 300 according to the read request 2 of the data 2 (step S1608).

The storage control device 100 receives a response to the write command of the data 1, from the SSD 301 (step S1609). Even though there is a response to the write command of the data 1, since the SSD 300 as a target of the read request 1 of the data 1 is in the execution of GC, the storage control device 100 transmits the read command of the data 1 to the SSD 301 instead of the SSD 300 (step S1610). The storage control device 100 outputs the write completion of the data 1 (step S1611).

The storage control device 100 receives a response to the write command of the data 2, from the SSD 302 (step S1612). When there is a response to the write command of the data 2, the storage control device 100 transmits the read command of the data 2 according to the read request 2 of the data 2, to the SSD 302 (step S1613). In addition, the storage control device 100 receives a response to the write command of the data 2, from the SSD 303 (step S1614). The storage control device 100 outputs the write completion of the data 2 (step S1615).

The storage control device 100 receives the data 1 according to the read request 1, from the SSD 301 (step S1616). The storage control device 100 outputs the read completion of the data 1 (step S1617). The storage control device 100 receives the data 2 according to the read request 2, from the SSD 302 (step S1618). The storage control device 100 outputs the read completion of the data 2 (step S1619).

When the SSD 300 completes GC, the storage control device 100 transmits the write command of the data 1 according to the write request 1, to the SSD 300 (step S1620). The storage control device 100 receives a response to the write command of the data 1, from the SSD 300 (step S1621).

Another Example of Flow of Operation of Storage Control Device 100

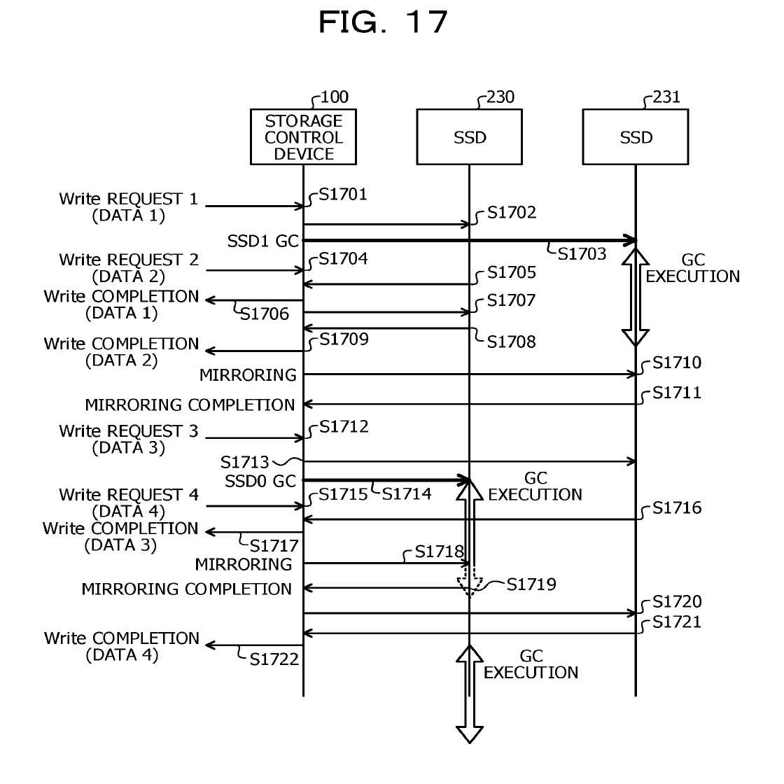

Next, another example of a flow of the operation of the storage control device 100 in the storage control system 200 illustrated in FIG. 2 will be described with reference to FIG. 17. Another example is an example for a case where the storage control device 100 performs the above-described rearrangement writing.

FIG. 17 is a sequence diagram illustrating another example of a flow of the operation of the storage control device 100 in the storage control system 200 illustrated in FIG. 2. In FIG. 17, the storage control device 100 receives a write request 1 of data 1 (step S1701). The storage control device 100 transmits a write command of the data 1 to the SSD 230, according to the write request 1 (step S1702).

At this time, since the capacity of the free space of the SSD 231 is equal to or less than a threshold value, the storage control device 100 transmits a command for GC execution to the SSD 231, without transmitting the write command of the data 1 according to the write request 1, to the SSD 231 (step S1703). Since the write command of the data 1 according to the write request 1 is not transmitted to the SSD 231, the storage control device 100 stores the data 1 according to the write request 1 is in a queue in correlation with the SSD 231.

The storage control device 100 further receives a write request 2 of the data 2, but waits until there is a response to the write command of the data 1, before transmitting a write command of the data 2 to the SSD 230 according to the write request 2 of the data 2 (step S1704). The storage control device 100 receives a response to the write command of the data 1, from the SSD 230 (step S1705). The storage control device 100 outputs the write completion of the data 1 (step S1706).

When a response to the write command of the data 1 is received from the SSD 230, the storage control device 100 transmits the write command of the data 2 to the SSD 230 according to the write request 2 (step S1707). Since the SSD 231 is in the execution of GC, the storage control device 100 stores the data 2 according to the write request 2 in a queue in correlation with the SSD 231, without transmitting the write command of the data 2 according to the write request 2, to the SSD 231.

The storage control device 100 receives a response to the write command of the data 2, from the SSD 230 (step S1708). The storage control device 100 outputs the write completion of the data 2 (step S1709). When the SSD 231 completes GC, the storage control device 100 collectively transmits the write command of the data 1 according to the write request 1 and the write command of the data 2 according to the write request 2, to the SSD 231 (step S1710). The storage control device 100 receives a response to the write command of the data 1 and a response to the write command of the data 2, from the SSD 231 (step S1711).

The storage control device 100 receives a write request 3 of data 3 (step S1712). The storage control device 100 transmits a write command of the data 3 to the SSD 231, according to the write request 3 (step S1713).

At this time, since the capacity of the free space of the SSD 230 is equal to or less than a threshold value, the storage control device 100 transmits a command for GC execution to the SSD 230, without transmitting the write command of the data 3 according to the write request 3, to the SSD 230 (step S1714). Since the write command of the data 3 according to the write request 3 is not transmitted to the SSD 230, the storage control device 100 stores the data 3 according to the write request 3 is in a queue in correlation with the SSD 230.

The storage control device 100 further receives a write request 4 of the data 4, but waits until there is a response to the write command of the data 3, before transmitting a write command of the data 4 to the SSD 231 according to the write request 4 of the data 4 (step S1715). Here, it is assumed that the data 4 and the data 3 are data to be written in the same unit storage area of the SSD 230. The storage control device 100 receives a response to the write command of the data 3, from the SSD 231 (step S1716). The storage control device 100 outputs the write completion of the data 3 (step S1717).

Since the data 4 and the data 3 are data to be written in the same unit storage area of the SSD 230, the storage control device 100 transmits the write command of the data 3 to the SSD 230 (step S1718). Since the write command has a higher priority than GC, the SSD 230 stops GC. The storage control device 100 receives a response to the write command of the data 3, from the SSD 230 (step S1719). When the processing according to the write command is completed, the SSD 230 restarts stopped GC.

Since a response to the write command of the data 3 is received from the SSD 231, the storage control device 100 transmits the write command of the data 4 according to the write request 4, to the SSD 231 (step S1720). The storage control device 100 receives a response to the write command of the data 4, from the SSD 231 (step S1721). The storage control device 100 outputs the write completion of the data 4 (step S1722).

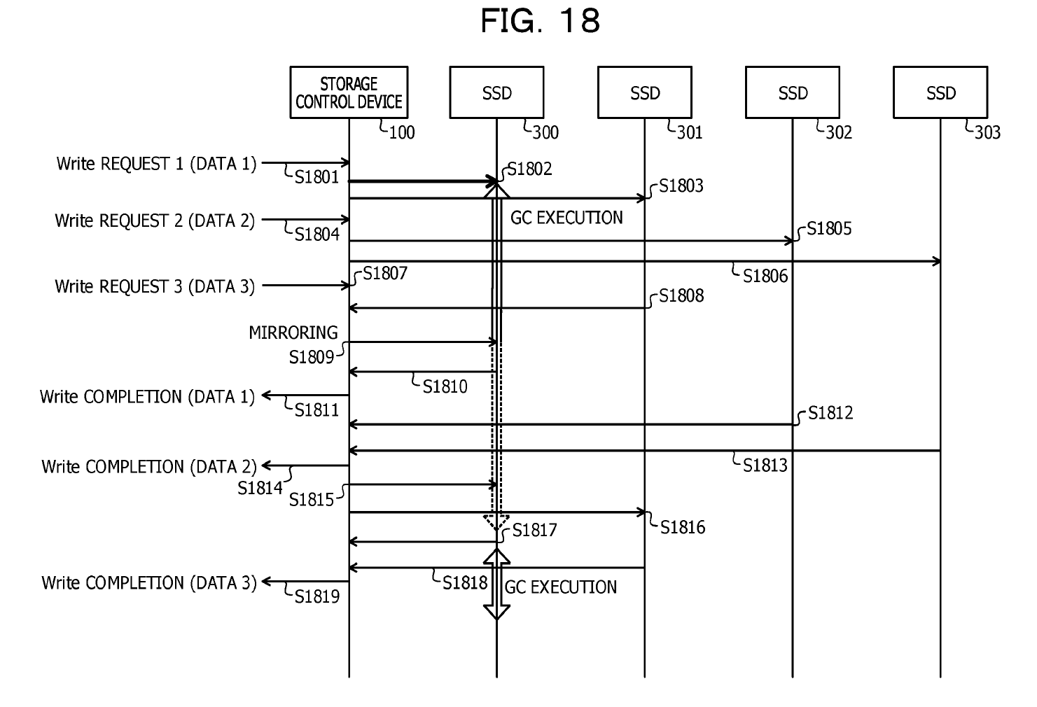

Next, another example of a flow of the operation of the storage control device 100 in the storage control system 200 illustrated in FIG. 3 will be described with reference to FIG. 18.

FIG. 18 is a sequence diagram illustrating another example of a flow of the operation of the storage control device 100 in the storage control system 200 illustrated in FIG. 3. In FIG. 18, the storage control device 100 receives a write request 1 of data 1 (step S1801). At this time, since the capacity of the free space of the SSD 300 is equal to or less than a threshold value, the storage control device 100 transmits a command for GC execution to the SSD 300, before transmitting the write command of the data 1 according to the write request 1, to the SSD 300 (step S1802). In addition, the storage control device 100 transmits a write command of the data 1 to the SSD 301, according to the write request 1 (step S1803).

The storage control device 100 receives a write request 2 of data 2 (step S1804). The storage control device 100 transmits a write command of the data 2 to the SSD 302, according to the write request 2 (step S1805). In addition, the storage control device 100 transmits a write command of the data 2 to the SSD 303, according to the write request 2 (step S1806).

The storage control device 100 receives a write request 3 of data 3 (step S1807). Here, it is assumed that the data 1 and the data 3 are data to be written in the same unit storage area of the SSD 300. The storage control device 100 receives a response to the write command of the data 1, from the SSD 301 (step S1808).

In addition, since the data 1 and the data 3 are data to be written in the same unit storage area of the SSD 300, the storage control device 100 transmits the write command of the data 1 to the SSD 300 (step S1809). Since the write command has a higher priority than GC, the SSD 300 stops GC. The storage control device 100 receives a response to the write command of the data 1, from the SSD 300 (step S1810). The storage control device 100 outputs the write completion of the data 1 (step S1811).

The storage control device 100 receives a response to the write command of the data 2, from the SSD 302 (step S1812). In addition, the storage control device 100 receives a response to the write command of the data 2, from the SSD 303 (step S1813). The storage control device 100 outputs the write completion of the data 2 (step S1814).

When the SSD 300 stops GC, the storage control device 100 transmits the write command of the data 3 according to the write request 3, to the SSD 300 (step S1815). In addition, the storage control device 100 transmits a write command of the data 3 according to the write request 3, to the SSD 301 (step S1816).

The storage control device 100 receives a response to the write command of the data 3, from the SSD 300 (step S1817). When the processing according to a series of write commands is completed, the SSD 300 restarts stopped GC. In addition, the storage control device 100 receives a response to the write command of the data 3, from the SSD 301 (step S1818). The storage control device 100 outputs the write completion of the data 3 (step S1819).

Operation of Storage Control Device 100 in Storage Control System 200

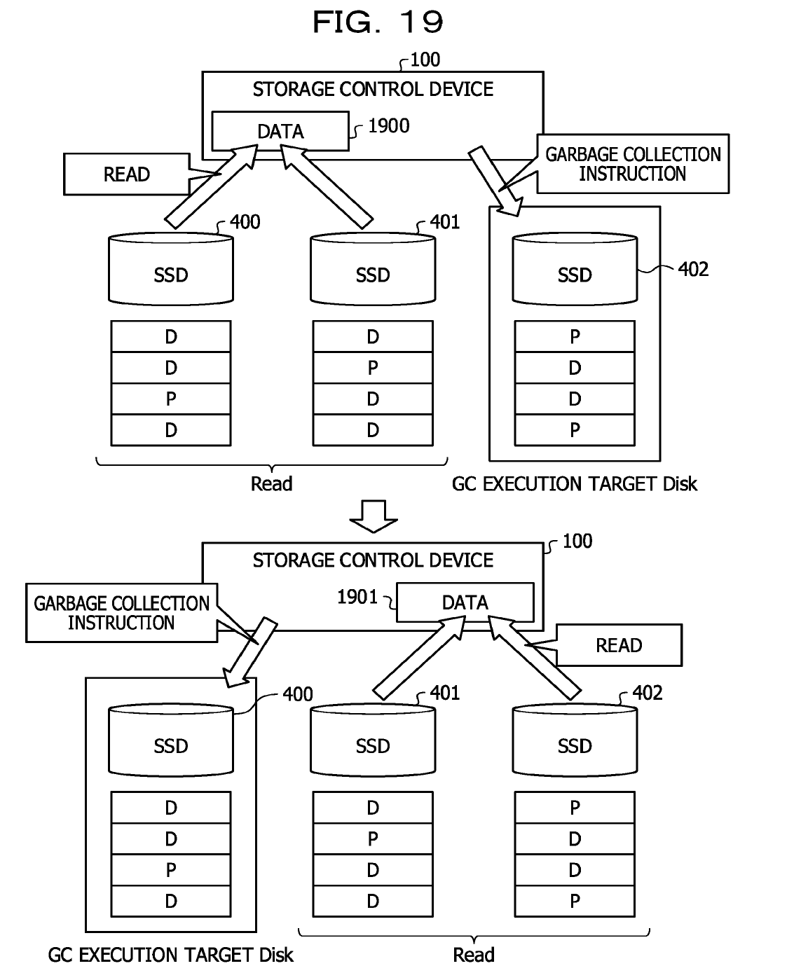

Next, the operation of the storage control device 100 in a third example of the storage control system 200 illustrated in FIG. 4 will be described with reference to FIGS. 19 to 22.

FIG. 19 is an explanatory diagram illustrating an example of reading of data in the storage control system 200 illustrated in FIG. 4. In FIG. 19, as in FIG. 12, it is assumed that the storage control device 100 updates the SSD state table 900 by acquiring the capacity of the free space of each of the SSDs 400 to 402 from each of the SSDs 400 to 402 at a predetermined time interval.

The storage control device 100 determines whether or not the capacity of a free space of each of the SSDs 400 to 402 is equal to or less than a high threshold value. For example, in a case where the capacity of a free space of the SSD 402 is equal to or less than a high threshold value, the storage control device 100 issues a command for causing the SSD 402 to execute GC. The storage control device 100 manages the GC execution state of the SSD 402 using the SSD state table 900.

Here, until the SSD 402 completes GC, the storage control device 100 cause the SSD 400 and the SSD 401, which are different from the SSD 402, not to execute GC. The storage control device 100 reads data 1900 from the SSD 400 and the SSD 401 until the SSD 402 completes GC.

Specifically, in a case where the data 1900 is distributed in the SSD 400 and the SSD 401, the storage control device 100 reads each portion of the data 1900 from the SSD 400 and the SSD 401, and generates the data 1900. In addition, specifically, in a case where a portion of the data 1900 and an error correction code are distributed in the SSD 400 and the SSD 401, the storage control device 100 generates the data 1900 based on a portion of the data 1900 and the error correction code.

Thereafter, in a case where the capacity of a free space of the SSD 400 is equal to or less than a high threshold value, the storage control device 100 issues a command for causing the SSD 400 to execute GC. Here, until the SSD 400 completes GC, the storage control device 100 cause the SSD 401 and the SSD 402, which are different from the SSD 400, not to execute GC. The storage control device 100 reads data 1901 from the SSD 401 and the SSD 402 until the SSD 400 completes GC.

Specifically, in a case where the data 1901 is distributed in the SSD 401 and the SSD 402, the storage control device 100 reads each portion of the data 1901 from the SSD 401 and the SSD 402, and generates the data 1901. In addition, specifically, in a case where a portion of the data 1901 and an error correction code are distributed in the SSD 401 and the SSD 402, the storage control device 100 generates the data 1901 based on a portion of the data 1901 and the error correction code.

Accordingly, the storage control device 100 may cause one group of SSDs, which store data being distributed using an error correction code, not to simultaneously execute GC. When one SSD among one group of SSDs is in the execution of GC, the storage control device 100 may cause at least the remaining SSDs to be in a state where reading of data is possible. As a result, even when any one SSD as a target of the read request is in the execution of GC, the storage control device 100 may generate the data requested to be read, and respond to a request source of the read request.

Although a case where the storage control device 100 reads data from an SSD in which GC is not in the execution while managing the GC execution states of SSDs by causing the SSDs to execute GC, is described, the embodiments described herein are not limited thereto. For example, the storage control device 100 may determine whether or not each SSD is in the execution of GC based on the capacity of a free space of each SSD, and determine an SSD for reading of data.

Specifically, for example, there is a case where the capacity of a free space of the SSD 400 is equal to or less than a low threshold value, and where the capacities of free spaces of the SSD 401 and the SSD 402 are greater than a low threshold value. In this case, the storage control device 100 determines that the SSD 400 is in the execution of GC and that the SSD 401 and the SSD 402 are not in the execution of GC, and reads data from the SSD 401 and the SSD 402. Accordingly, even when an SSD as a target of the read request is in the execution of GC, the storage control device 100 may acquire data having the same contents as the data requested to be read, and respond to a request source of the read request.

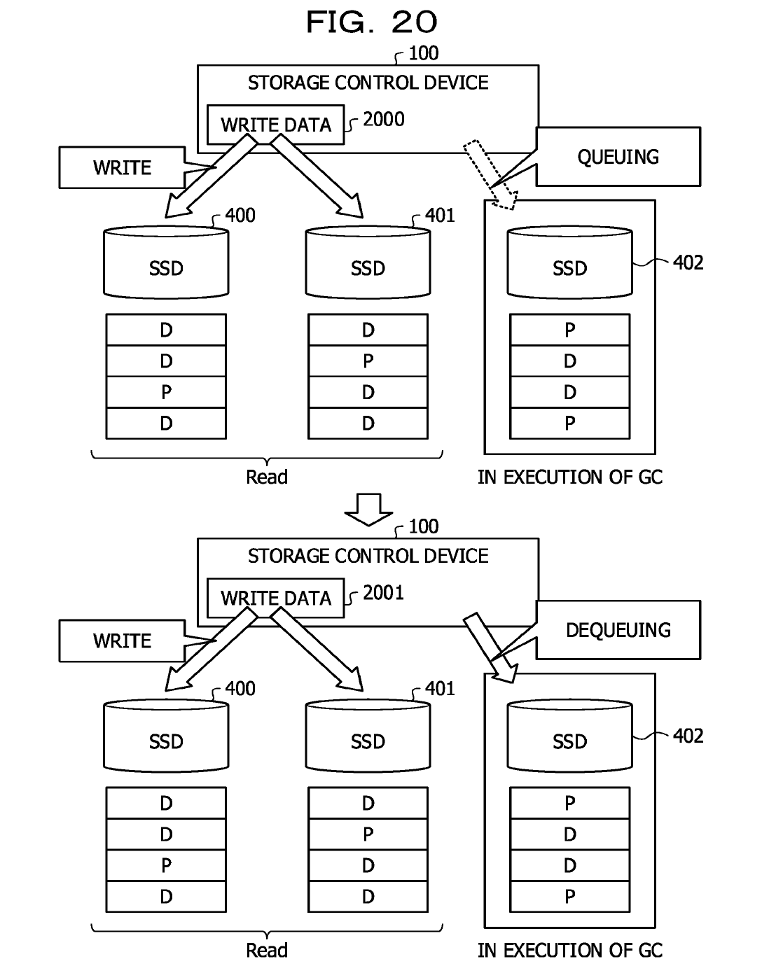

In addition, the storage control device 100 may determine an SSD for reading of data by, for example, inquiring of each SSD whether or not GC is in the execution. Accordingly, even when an SSD as a target of the read request is in the execution of GC, the storage control device 100 may acquire data having the same contents as the data requested to be read, and respond to a request source of the read request. The description proceeds to the explanation of FIG. 20.

FIG. 20 is an explanatory diagram illustrating an example of writing of data in the storage control system 200 illustrated in FIG. 4. In FIG. 20, it is assumed that the storage control device 100 receives a write request for writing write data 2000 in the SSD 402 while the SSD 402 is in the execution of GC.

The storage control device 100 distributes the write data 2000 and writes the distributed write data 2000 in the SSD 400 and the SSD 401, and writes the error correction code corresponding to the write data 2000, in the SSD 402. The storage control device 100 responds to a request source of the write request when receiving the write request, even before the write data is written in the SSD 400 to the SSD 402 in a write-back format.

At this time, since the SSD 402 is in the execution of GC, the storage control device 100 stores, in a queue, an error correction code corresponding to the write data 2000 in correlation with the SSD 402, and waits for the error correction code to be written in the SSD 402. On the other hand, the storage control device 100 distributes the write data 2000, and writes the distributed write data 2000 in the SSD 400 and the SSD 401.

Thereafter, when the SSD 402 completes GC, the storage control device 100 writes, in the SSD 402, the error correction code stored in the queue. When there are a plurality of pieces of data stored in the queue, the storage control device 100 collectively writes the plurality of pieces of data in the SSD, and thus the number of times of writing may be reduced.

In addition, it is assumed that, before the SSD 402 completes GC, the storage control device 100 receives a write request for overwriting the write data 2000 with write data 2001 in the SSD 400 and the SSD 401. Here, the storage control device 100 overwrites the write data 2000 with the write data 2001 in the SSD 400 and the SSD 401. In addition, the storage control device 100 overwrites, in the SSD 402, the error correction code corresponding to the write data 2000 with the error correction code corresponding to the write data 2001.

At this time, according to the write-back format, even before the write data 2001 and the error correction code are written, the storage control device 100 responds to a request source of the write request when receiving the write request. However, in some cases, it may not be preferable to respond to a request source of the current write request according to the write-back format unless the write data 2000 previously requested to be written and the error correction code are written in the SSDs.

Therefore, the storage control device 100 causes the SSD 402 to stop GC, extracts the error correction code corresponding to the write data 2000 from the queue, and writes the error correction code corresponding to the write data 2000 in the SSD 402. When the error correction code is written in the SSD 402, the storage control device 100 responds to a request source of the write request of the write data 2001. The storage control device 100 stores, in a queue, an error correction code corresponding to the write data 2001 in correlation with the SSD 402, causes the SSD 402 to restart GC, and waits for the error correction code to be written in the SSD 402.

The storage control device 100 may further write the error correction code corresponding to the write data 2001 in the SSD 402, and then causes the SSD 402 to restart GC. On the other hand, the storage control device 100 distributes the write data 2001, and writes the distributed write data 2001 in the SSD 400 and the SSD 401. Accordingly, even in a case where it is not preferable to respond to a request source of the current write request unless the data previously requested to be written is written in the SSD, the storage control device 100 may reduce deterioration in response performance for an access request.

Although a case where it is not preferable to respond to a request source of the current write request unless the write data previously requested to be written and the error correction code are written in the SSDs, is described, the embodiments described herein are not limited thereto. For example, in some cases, even when the write data previously requested to be written and the error correction code are not written in the SSDs, it may be preferable to respond to a request source of the current write request. In this case, the storage control device 100 may merge the write data previously requested to be written and the error correction code, with the write data currently requested to be written and the error correction code, and store the new write data and the new error correction code in a queue. Accordingly, the storage control device 100 may reduce deterioration in write performance.

Although a case where it is not preferable to respond to a request source of the current write request unless the write data previously requested to be written and the error correction code are written in the SSDs, is described, the embodiments described herein are not limited thereto. For example, in some cases, it may not be preferable to respond to a request source of the read request for reading the write data previously requested to be written unless the write data previously requested to be written and the error correction code are written in the SSDs. In this case, the storage control device 100 causes the SSD to stop GC, writes the write data previously requested to be written and the error correction code in the SSDs, and then responds to a request source of the read request. Accordingly, the storage control device 100 may reduce deterioration in response performance for an access request.

In addition, for example, in some cases, even when the write data previously requested to be written and the error correction code are not written in the SSDs, it may be preferable to respond to a request source of the read request for reading the write data previously requested to be written. In this case, the storage control device 100 generates, from an SSD in which GC is not in the execution, the data requested to be read, and responds to a request source of the read request. Accordingly, the storage control device 100 may reduce deterioration in response performance for an access request.

Example of Flow of Operation of Storage Control Device 100

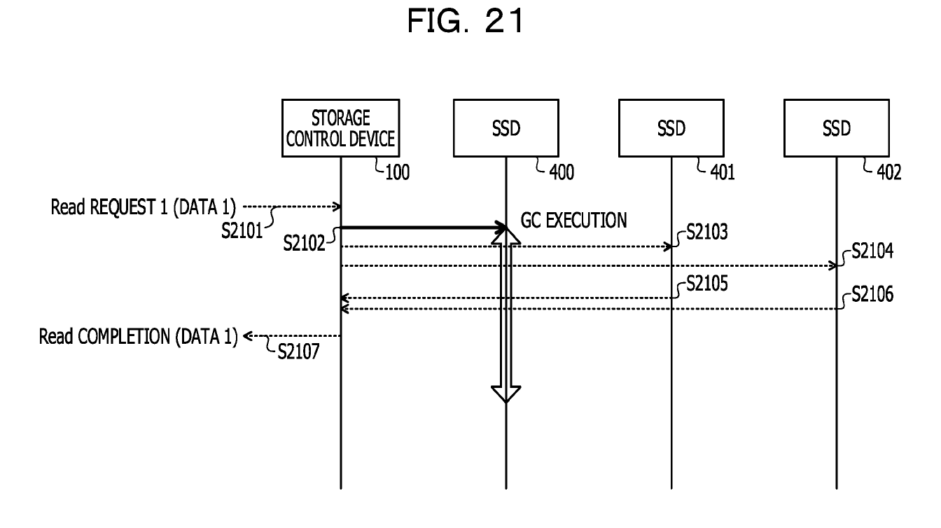

Next, an example of a flow of the operation of the storage control device 100 in the storage control system 200 illustrated in FIG. 4 will be described with reference to FIG. 21.

FIG. 21 is a sequence diagram illustrating an example of a flow of the operation of the storage control device 100 in the storage control system 200 illustrated in FIG. 4. In FIG. 21, the storage control device 100 receives a read request 1 of data 1 (step S2101). At this time, since the capacity of the free space of the SSD 400 is equal to or less than a threshold value, the storage control device 100 transmits a command for GC execution to the SSD 400, before transmitting the read command of the data 1 according to the read request 1, to the SSD 400 (step S2102).

The storage control device 100 transmits a read command of the data 1 to the SSD 401, according to the read request 1 of the data 1 (step S2103). Since the SSD 400 is in the execution of GC, the storage control device 100 transmits a read command of the error correction code corresponding to the data 1 to the SSD 402, without transmitting the read command of the data 1 according to the read request 1 of the data 1 to the SSD 400 (step S2104).

The storage control device 100 receives a portion of the data 1 according to the read request 1, from the SSD 401 (step S2105). The storage control device 100 receives, from the SSD 402, the error correction code corresponding to the data 1 according to the read request 1, and generates the data 1 (step S2106). The storage control device 100 outputs the read completion of the data 1 (step S2107).

Another Example of Flow of Operation of Storage Control Device 100

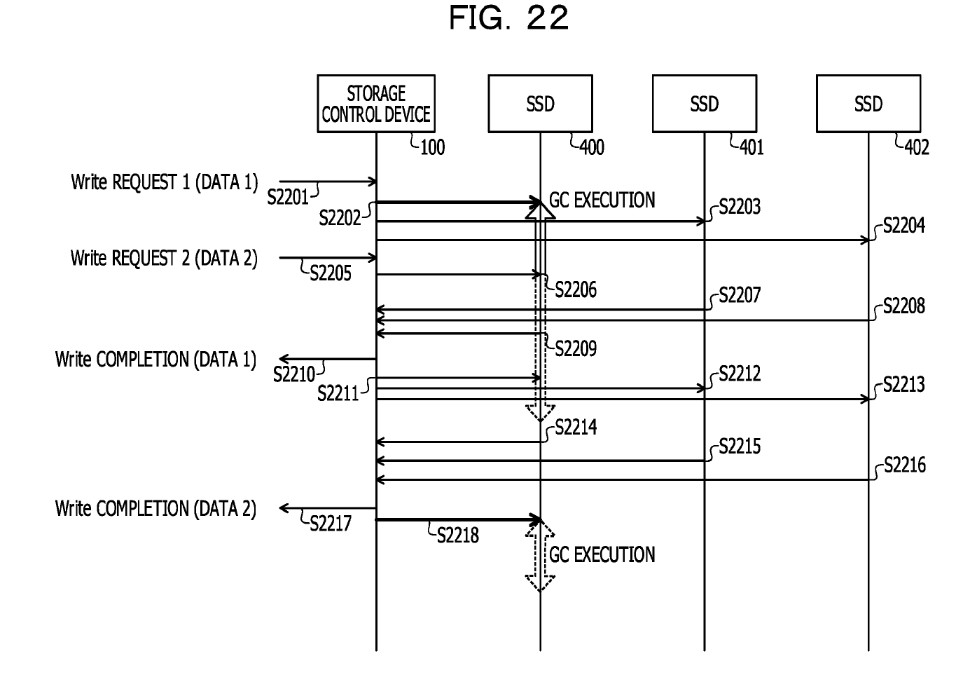

Next, another example of a flow of the operation of the storage control device 100 in the storage control system 200 illustrated in FIG. 4 will be described with reference to FIG. 22. Another example is an example for a case where the storage control device 100 performs the above-described rearrangement writing.

FIG. 22 is a sequence diagram illustrating another example of a flow of the operation of the storage control device 100 in the storage control system 200 illustrated in FIG. 4. In FIG. 22, the storage control device 100 receives a write request 1 of data 1 (step S2201).

At this time, since the capacity of the free space of the SSD 400 is equal to or less than a threshold value, the storage control device 100 transmits a command for GC execution to the SSD 400, before transmitting the write command of the data 1 according to the write request 1, to the SSD 400 (step S2202). Since the SSD 400 is in the execution of GC, the storage control device 100 stores a portion of the data 1 according to the write request 1 in a queue in correlation with the SSD 400, without transmitting the write command of the data 1 according to the write request 1, to the SSD 400.

In addition, the storage control device 100 transmits a write command of the data 1 to the SSD 401, according to the write request 1 (step S2203). In addition, the storage control device 100 transmits, to the SSD 402, a write command of the error correction code corresponding to the data 1, according to the write request 1 (step S2204).

The storage control device 100 receives a write request 2 of data 2 (step S2205). Here, it is assumed that the data 1 and the data 2 are data to be written in the same unit storage area of the SSD 400. Since the data 1 and the data 2 are data to be written in the same unit storage area of the SSD 400, the storage control device 100 transmits the write command of the data 1 to the SSD 400 (step S2206). Since the write command has a higher priority than GC, the SSD 400 stops GC.

The storage control device 100 receives a response to the write command of the data 1, from the SSD 401 (step S2207). In addition, the storage control device 100 receives a response to the write command of the data 1, from the SSD 402 (step S2208). In addition, the storage control device 100 receives a response to the write command of the data 1, from the SSD 400 (step S2209). The storage control device 100 outputs the write completion of the data 1 (step S2210).

The storage control device 100 transmits, to the SSD 400, a write command of the data 2 according to the write request 2 (step S2211). In addition, the storage control device 100 transmits a write command of the data 2 according to the write request 2, to the SSD 401 (step S2212). In addition, the storage control device 100 transmits a write command of the data 2 according to the write request 2, to the SSD 402 (step S2213).

The storage control device 100 receives a response to the write command of the data 2, from the SSD 400 (step S2214). In addition, the storage control device 100 receives a response to the write command of the data 2, from the SSD 401 (step S2215). In addition, the storage control device 100 receives a response to the write command of the data 2, from the SSD 402 (step S2216). The storage control device 100 outputs the write completion of the data 2 (step S2217). The storage control device 100 transmits a command for GC execution to the SSD 400 (step S2218).

Example of GC Initialization Processing Procedure

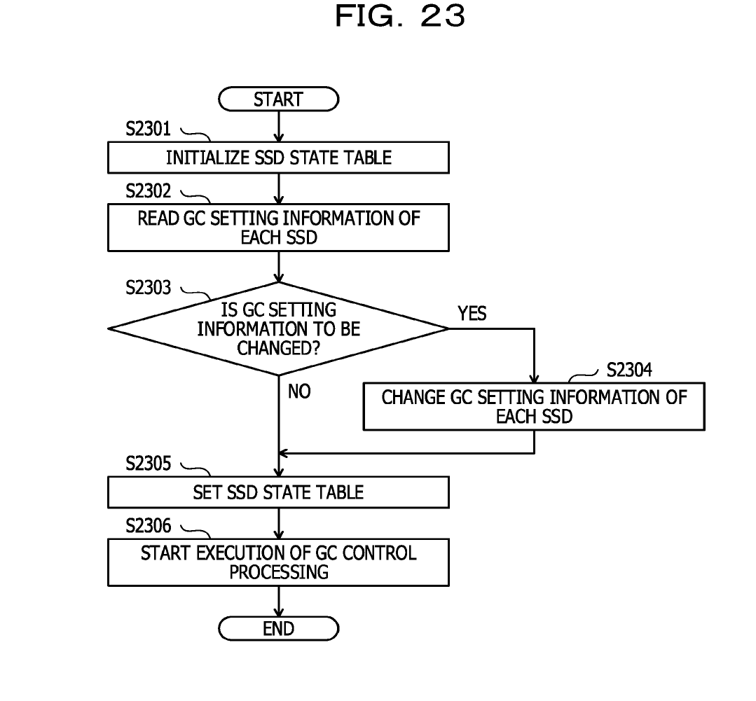

Next, an example of GC initialization processing procedure executed by the storage control device 100 will be described with reference to FIG. 23.

FIG. 23 is a flowchart illustrating an example of GC initialization processing procedure. In FIG. 23, the storage control device 100 initializes the SSD state table 900 (step S2301). Next, the storage control device 100 reads GC setting information of each SSD (step S2302). The storage control device 100 determines whether or not the GC setting information is to be changed (step S2303). In a case where the GC setting information is not to be changed (No in step S2303), the storage control device 100 transitions to processing of step S2305.

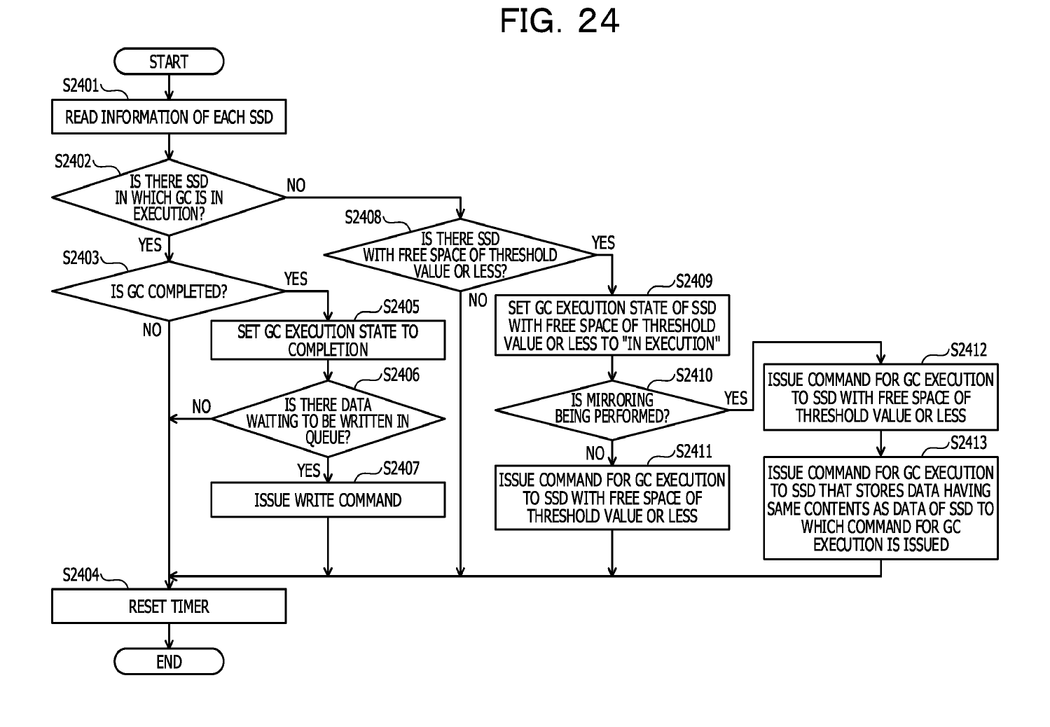

On the other hand, in a case where the GC setting information is to be changed (Yes in step S2303), the storage control device 100 changes the GC setting information of each SSD (step S2304). Next, the storage control device 100 sets the SSD state table 900 (step S2305). The storage control device 100 starts execution of the GC control processing 1102 to be described in FIG. 24 (step S2306), and completes the GC initialization processing 1101. Accordingly, the storage control device 100 may make read or write prior to GC in each SSD by changing the GC setting information of each SSD.

Example of GC Control Processing Procedure

Next, an example of GC control processing procedure executed by the storage control device 100 will be described with reference to FIG. 24.

FIG. 24 is a flowchart illustrating an example of GC control processing procedure. In FIG. 24, the storage control device 100 reads information of each SSD by referring to the SSD state table 900 (step S2401). The information of each SSD includes, for example, information indicating the capacity of a free space of each SSD, information indicating whether or not each SSD is in the execution of GC, and the like.

Next, the storage control device 100 determines whether or not there is an SSD in which GC is in the execution (step S2402). In a case where there is an SSD in which GC is in the execution (Yes in step S2402), the storage control device 100 determines whether or not GC is completed (step S2403). In a case where GC is still in the execution (No in step S2403), the storage control device 100 resets a timer that triggers execution start of the next GC control processing 1102 (step S2404), and completes GC control processing 1102.

On the other hand, in a case where GC is completed (Yes in step S2403), the storage control device 100 sets the GC execution state of the SSD state table 900 to completion (step S2405). Next, the storage control device 100 determines whether or not there is data waiting to be written in a queue (step S2406). In a case where there is data waiting to be written (Yes in step S2406), the storage control device 100 issues a write command (step S2407), and transitions to the processing of step S2404. On the other hand, in a case where there is no data waiting to be written (No in step S2406), the storage control device 100 transitions to the processing of step S2404.

In step S2402, in a case where there is no SSD in which GC is in the execution (No in step S2402), the storage control device 100 determines whether or not there is an SSD with a free space of which the capacity is equal to or less than a threshold value (step S2408). In a case where there is no SSD with a free space of which the capacity is equal to or less than the threshold value (No in step S2408), the storage control device 100 transitions to the processing of step S2404.

On the other hand, in a case where there is an SSD with a free space of which the capacity is equal to or less than the threshold value (Yes in step S2408), the storage control device 100 sets, in the SSD state table 900, the GC execution state of the SSD with a free space of which the capacity is equal to or less than the threshold value to “in execution” (step S2409). Next, the storage control device 100 determines whether or not mirroring is being performed (step S2410).

In a case where mirroring is not being performed (No in step S2410), the storage control device 100 issues a command for GC execution to the SSD with a free space of which the capacity is equal to or less than the threshold value (step S2411). When GC is completed, the storage control device 100 sets the GC execution state of the SSD state table 900 to “completion”, and transitions to the processing of step S2404.

On the other hand, in a case where mirroring is being performed (Yes in step S2410), the storage control device 100 issues a command for GC execution to the SSD with a free space of which the capacity is equal to or less than the threshold value, and waits until GC is completed (step S2412). When GC is completed, the storage control device 100 sets the GC execution state of the SSD state table 900 to “completion”.

Next, the storage control device 100 issues a command for GC execution to an SSD that stores data having the same contents as the data of the SSD to which the command for GC execution is issued, and sets the GC execution state of the SSD state table 900 to “in execution” (step S2413). When GC is completed, the storage control device 100 sets the GC execution state of the SSD state table 900 to “completion”.

Then, the storage control device 100 transitions to the processing of step S2404. Accordingly, the storage control device 100 may cause each SSD to execute GC, and in a case where mirroring is being performed, reduce a possibility that both of a pair of SSDs, which store data having the same contents, are in the execution of GC.

Example of Access Control Processing Procedure

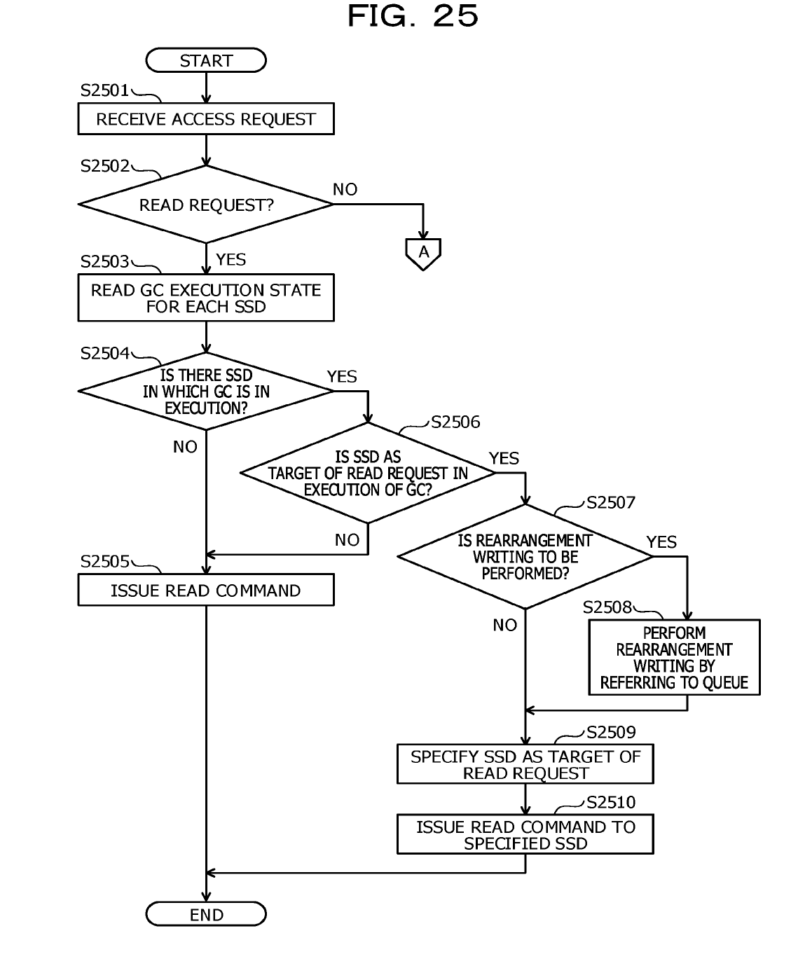

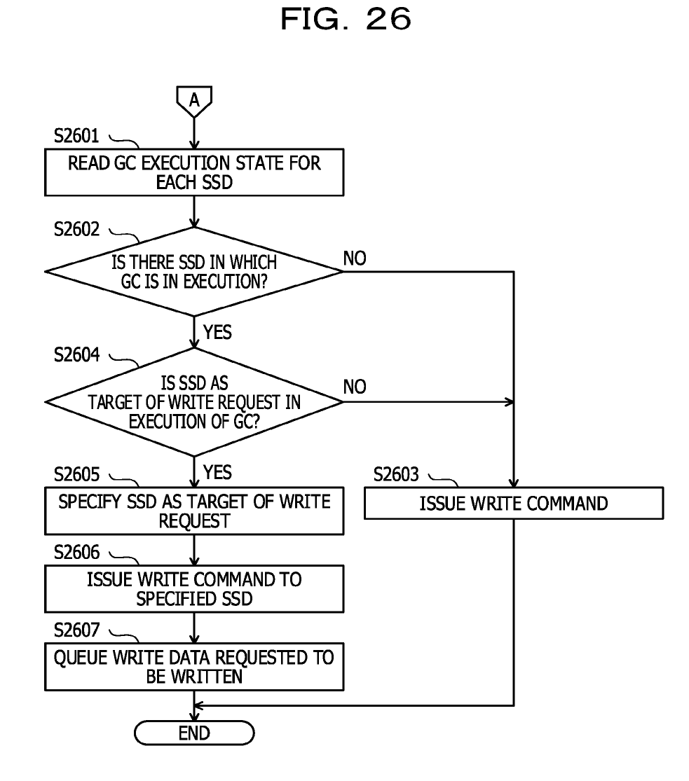

Next, an example of access control processing procedure executed by the storage control device 100 will be described with reference to FIGS. 25 and 26. The access control processing corresponds to, for example, the read processing 1103 and the write processing 1104.

FIGS. 25 and 26 are flowcharts illustrating an example of access control processing procedure. In FIG. 25, the storage control device 100 receives an access request (step S2501). Next, the storage control device 100 determines whether or not the access request is a read request (step S2502). In a case where the access request is a write request (No in step S2502), the storage control device 100 transitions to processing of step S2601 in FIG. 26.

On the other hand, in a case where the access request is a read request (Yes in step S2502), the storage control device 100 reads the GC execution state of the SSD state table 900 for each SSD (step S2503). Next, the storage control device 100 determines whether or not there is an SSD in which GC is in the execution (step S2504). In a case where there is no SSD in the execution of GC (No in step S2504), the storage control device 100 issues a read command (step S2505), and completes the access control processing.

On the other hand, in a case where there is an SSD in the execution of GC (Yes in step S2504), the storage control device 100 determines whether or not an SSD as a target of the read request is in the execution of GC (step S2506). In a case where the SSD as a target of the read request is not in the execution of GC (No in step S2506), the storage control device 100 transitions to the processing of step S2505.

On the other hand, in a case where the SSD as a target of the read request is in the execution of GC (Yes in step S2506), the storage control device 100 determines whether to perform rearrangement writing (step S2507). In a case where rearrangement writing is not to be performed (No in step S2507), the storage control device 100 transitions to processing of step S2509.

On the other hand, in a case where rearrangement writing is to be performed (Yes in step S2507), the storage control device 100 performs rearrangement writing by referring to a queue (step S2508). Next, the storage control device 100 specifies the SSD as a target of the read request (step S2509). Then, the storage control device 100 issues a read command to the specified SSD (step S2510), and completes the access control processing.

In FIG. 26, the storage control device 100 reads the GC execution state of the SSD state table 900 for each SSD (step S2601). Next, the storage control device 100 determines whether or not there is an SSD in which GC is in the execution (step S2602). In a case where there is no SSD in the execution of GC (No in step S2602), the storage control device 100 issues a write command (step S2603), and completes the access control processing.

On the other hand, in a case where there is an SSD in the execution of GC (Yes in step S2602), the storage control device 100 determines whether or not an SSD as a target of the write request is in the execution of GC (step S2604). In a case where the SSD as a target of the write request is not in the execution of GC (No in step S2604), the storage control device 100 transitions to the processing of step S2603.

On the other hand, in a case where the SSD as a target of the write request is in the execution of GC (Yes in step S2604), the storage control device 100 specifies the SSD as a target of the write request (step S2605). Next, the storage control device 100 issues a write command to the specified SSD (step S2606). Then, the storage control device 100 queues write data requested to be written (step S2607), and completes the access control processing.

As described above, the storage control device 100 may monitor whether or not each SSD, which is included in the plurality of SSDs that constitute the storage apparatus 210, is in the execution of GC. In addition, in a case where a read request to the storage apparatus 210 is received, the storage control device 100 may determine whether or not an SSD as a target of the read request among the plurality of SSDs is in the execution of GC. Further, when an SSD as a target of the read request is in the execution of GC, the storage control device 100 may acquire data requested to be read, from another SSD different from the SSD, which is a target of the read request, among the plurality of SSDs. Therefore, the storage control device 100 may respond to a request source of a read request when acquiring data having the same contents as the data requested to be read, without waiting until an SSD as a target of a read request completes GC. Accordingly, the storage control device 100 may reduce deterioration in response performance for an access request.

Further, the storage apparatus 210 is an apparatus that stores data by mirroring, and may have, for example, a RAID1 configuration. In this case, when an SSD as a target of the read request is in the execution of the GC, the storage control device 100 may acquire data which is stored in another SSD by mirroring and has the same contents as the data requested to be read. Accordingly, even before an SSD as a target of the read request completes GC, the storage control device 100 may acquire data having the same contents as the data requested to be read, and respond to a request source of the read request.

In addition, the storage control device 100 may measure the capacity of a free space of any one SSD, which is included in the plurality of SSDs, and when the measured capacity of the free space is equal to or less than a threshold value, cause the any one SSD to execute GC. Further, when the any one SSD completes GC, the storage control device 100 may cause the SSD, which stores data having the same contents as the data of the any one SSD by mirroring, to execute GC. Accordingly, the storage control device 100 may cause the plurality of SSDs, which store data having the same contents by mirroring, not to simultaneously execute GC.

In addition, the storage apparatus 210 is an apparatus that distributes data and stores the distributed data using an error correction code, and may have a RAID5 configuration in some cases. In this case, when an SSD, which stores a portion of the data requested to be read, is in the execution of GC, the storage control device 100 may acquire, from another SSD, the remaining portion of the data requested to be read, which is different from the portion. Further, the storage control device 100 may acquire, from another SSD, an error correction code corresponding to the data requested to be read. Furthermore, the storage control device 100 may generate the data requested to be read based on the acquired remaining portion and the error correction code. Accordingly, even before an SSD as a target of the read request completes GC, the storage control device 100 may generate data having the same contents as the data requested to be read by using the error correction code, and respond to a request source of the read request.

In addition, the storage apparatus 210 is an apparatus that distributes data and stores the distributed data using an error correction code, and may have a RAID5 configuration in some cases. In this case, when an SSD, which stores the error correction code corresponding to the data requested to be read, is in the execution of GC, the storage control device 100 may acquire, from other SSDs, each portion of the data requested to be read, and generate the data requested to be read. Accordingly, even before an SSD as a target of the read request completes GC, the storage control device 100 may generate data having the same contents as the data requested to be read, and respond to a request source of the read request.

In addition, the storage control device 100 may measure the capacity of a free space of any one SSD, which is included in the plurality of SSDs, and when the measured capacity of the free space is equal to or less than a threshold value, cause the any one SSD to execute GC. Accordingly, the storage control device 100 may cause the plurality of SSDs not to simultaneously execute GC.

In addition, the storage control device 100 may adopt a value, which is greater than the capacity of a free space when it is determined that any one SSD automatically executes GC, as a threshold value to be compared with the capacity of a free space. Accordingly, the storage control device 100 may cause an SSD not to automatically execute GC, and thus it is easier to manage whether or not an SSD is in the execution of GC.

In addition, in a case where a write request to the storage apparatus 210 is received, when an SSD as a target of the write request among the plurality of SSDs is in the execution of GC, the storage control device 100 may store the data requested to be written in a queue. Further, before an SSD as a target of the write request completes GC, in some cases, the storage control device 100 may receive an access request to a storage area as a write target of the data requested to be written. In this case, the storage control device 100 may cause an SSD, which is a target of the write request, to stop GC, and write the data requested to be written in the SSD as a target of the write request. Accordingly, the storage control device 100 may reduce deterioration in response performance for an access request.

In addition, when an SSD as a target of the write request completes GC, the storage control device 100 may collectively write data stored in a queue, in the SSD as a target of the write request. Accordingly, the storage control device 100 may reduce the number of times of writing.

Further, the storage control device 100 may respond to a request source of the read request when acquiring the data requested to be read. Accordingly, the storage control device 100 may reduce deterioration in response performance for an access request.

The storage control method described in this embodiment may be realized by executing a prepared program on a computer such as a personal computer or a workstation. The storage control program is recorded in a computer-readable recording medium such as a hard disk, a flexible disk, a CD-ROM, an MO, or a DVD, and is executed by reading from the recording medium by the computer. In addition, the storage control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device configured to control a storage apparatus including a plurality of storage devices configured to store data redundantly, the storage control device comprising:
a memory; and
a processor coupled to the memory and configured to:
receive a read request that requires to read first data stored in the storage apparatus,
determine whether, among the plurality of storage devices of the storage apparatus, a first storage device which stores the first data is under execution of garbage collection, and
acquire the first data by accessing a second storage device different from the first storage device, among the plurality of storage devices, when the first storage device is under the execution of the garbage collection.

2. The storage control device according to claim 1, wherein,
in acquiring the first data, the processor is configured to acquire the first data from the second storage device which stores the first data.

3. The storage control device according to claim 2, wherein
the second storage device is configured to store the first data by mirroring.

4. The storage control device according to claim 1, wherein
in acquiring the first data, the processor is configured to generate the first data, based on second data stored in the second storage device, and an error correction code generated based on the first data and the second data, the error correction code being stored in a third storage device different from the first storage device and the second storage device, among the plurality of storage devices.

5. The storage control device according to claim 4, wherein
the processor is configured to acquire the first data from the first storage device when the third storage device is under execution of the garbage collection.

6. The storage control device according to claim 3, wherein
the processor is configured to:
specify capacity of a free space of the first storage device,
cause the first storage device to execute the garbage collection when the capacity of the free space is equal to or less than a first value, and
cause the second storage device to execute the garbage collection after the garbage collection of the first storage device is completed.

7. The storage control device according to claim 4, wherein
the processor is configured to:
specify capacity of a free space of any one storage device of the plurality of storage devices, and
cause the any one storage device to execute the garbage collection when the capacity of the free space is equal to or less than a first value.

8. The storage control device according to claim 7, wherein
when the capacity of the free space is less than a second value lower than the first value, the any one storage device executes the garbage collection regardless of control of the processor.

9. The storage control device according to claim 1, wherein
the processor is configured to:
receive a write request that requires to write third data to the storage apparatus,
store the third data in a buffer when a fourth storage device which is a target of the write request among the plurality of storage devices is under the execution of the garbage collection, and
cause the fourth storage device to stop the garbage collection and write the third data stored in the buffer in the fourth storage device, when an access request to the fourth storage device is received before the fourth storage device completes the garbage collection.

10. The storage control device according to claim 9, wherein
the processor is configured to write the third data stored in the buffer in the fourth storage device after the garbage collection of the fourth storage device is completed.

11. The storage control device according to claim 1, wherein
the processor is configured to transmit a response notice to a request source apparatus of the read request after the first data is acquired.

12. A storage system comprising:
a plurality of storage devices configured to store data redundantly; and
a control device including a memory and a processor coupled to the memory, wherein the processor is configured to:
receive a read request that requires to read first data stored in the storage system,
determine whether, among the plurality of storage devices, a first storage device which stores the first data is under execution of garbage collection, and
acquire the first data by accessing a second storage device different from the first storage device, among the plurality of storage devices, when the first storage device is under the execution of the garbage collection.

13. The storage system according to claim 12, wherein,
in acquiring the first data, the processor is configured to acquire the first data from the second storage device which stores the first data.

14. The storage system according to claim 13, wherein
the second storage device is configured to store the first data by mirroring.

15. The storage system according to claim 12, wherein
in acquiring the first data, the processor is configured to generate the first data, based on second data stored in the second storage device, and an error correction code generated based on the first data and the second data, the error correction code being stored in a third storage device different from the first storage device and the second storage device, among the plurality of storage devices.

16. The storage system according to claim 15, wherein
the processor is configured to acquire the first data from the first storage device when the third storage device is under execution of the garbage collection.

17. The storage system according to claim 14, wherein
the processor is configured to:
specify capacity of a free space of the first storage device,
cause the first storage device to execute the garbage collection when the capacity of the free space is equal to or less than a first value, and
cause the second storage device to execute the garbage collection after the garbage collection of the first storage device is completed.

18. The storage system according to claim 15, wherein the processor is configured to:
specify capacity of a free space of any one storage device of the plurality of storage devices, and
cause the any one storage device to execute the garbage collection when the capacity of the free space is equal to or less than a first value.

19. The storage system according to claim 18, wherein
when the capacity of the free space is less than a second value lower than the first value, the any one storage device executes the garbage collection regardless of control of the processor.

20. A method of controlling a storage system including a storage control device and a plurality of storage devices configured to store data redundantly, the method comprising:
receiving, by the storage control device, a read request that requires to read first data stored in the storage system;
determining, by the storage control device, whether, among the plurality of storage devices, a first storage device which stores the first data is under execution of garbage collection; and
acquiring, by the storage control device, the first data by accessing a second storage device different from the first storage device, among the plurality of storage devices, when the first storage device is under the execution of the garbage collection.
